(19) United States
(12) Patent Application Publication
(10) Pub. No.: US 2019/0333314 A1
(43) Pub. Date: Oct. 31, 2019

(54) RAFFLE TOURNAMENT GAME DESIGN

(71) Applicant: Robert John Henshaw, Henderson, NV (US)

(72) Inventor: Robert John Henshaw, Henderson, NV (US)

(21) Appl. No.: 15/964,640

(22) Filed: Apr. 27, 2018

(51) Int. Cl. G07F 17/32

(52) U.S. Cl. CPC G07F 17/329; G07F 17/3244

(57) ABSTRACT

For a raffle tournament game, randomly selecting a predetermined number of event codes, for each event code, randomly selecting a playing symbol from O to 9 for each place value of the total number of tickets dispensed to players up to one of the following; zero place values away from the total, one place value away from the total, two place values away from the total, three place values away from the total, four place values away from the total, five place values away from the total, six place values away from the total, seven place values away from the total, eight place values away from the total, nine place values away from the total, the event code identifies playing symbols which need to match the specific subset of playing symbols on the raffle array, whereby matching raffle array to event code wins an entry into a tournament event,

### CROSS-REFERENCE TO RELATED APPLICATIONS

This application claims the benefit of provisional patent application Ser. No. 15/964,640, filed 2017 April 27 by the present inventor

### FEDERALLY SPONSORED RESEARCH

None

### SEQUENCE LISTING

None

### BACKGROUND

### Prior Art

The following is a tabulation of some prior art that presently appears relevant:

U.S. PATENTS

| Pat. No. | Kind Code | Issue Date | Patentee |
|---|---|---|---|
| U.S. Pat. No. 5,727,786 A1 | 273/269,274 | 1998 Apr. 17 | Weingardt |
| U.S. Pat. No. 5,909,875 | 273/269,274 | 199-06-08 | Weingardt |
| U.S. Pat. No. 6,702,668 B2 | 463/17,273/292,274 | 2004 Mar. 9 | Banyai |
| U.S. Pat. No. 7,883,405 B2 | 463/16,17,18,20,42 | 2011 Feb. 8 | Robb |
| U.S. Pat. No. 8,221,213 B2 | 463/16,17,18,19,20 | 2012 Jul. 17 | Martineck |
| U.S. Pat. No. 8,512,119 B2 | 463/16,25,29 | 2013 Aug. 20 | Kelly |
| U.S. Pat. No. 8,523,650 B2 | 463/16 | 2013 Sep. 3 | Kelly |
| U.S. Pat. No. 8,678,902 B2 | A63F13/00, A63F9/24 | 2014 Mar. 25 | Kelly |
| U.S. Pat. No. 8,702,499 B2 | 463/16,20,25,29 | 2014 Apr. 22 | Johnson |
| U.S. Pat. No. 9,123,205 B2 | G07F17/32 | 2015 Sep. 1 | Weingardt |
| U.S. Pat. No. 7,798,901 B2 | G07F17/32 | 2010-0821 | Nguyen |
| U.S. Pat. No. 8,702,520 B2 | G07F17/00 A63F9/24 | 2014 Apr. 22 | Seelig |
| U.S. Pat. No. 8,660,661 | G07F17/32 | 2014 Apr. 8 | Cannon |
| U.S. Pat. No. 8,894,480 B2 | G07F17/32 | 2014 Nov. 25 | Johnson |
| U.S. Pat. No. 6,039,649 | G07F17/32 | 2000 Mar. 21 | Guinn |
| U.S. Pat. No. 6,309,299 B1 | A63F9/24 | 2001 Oct. 30 | Kelly |
| U.S. Pat. No. 7,213,811 B2 | A63F13/06 | 2007 May 8 | Bozeman |
| U.S. Pat. No. 8,480,470 B2 | A63F13/00 | 2013 Jul. 9 | Napolitano |
| U.S. Pat. No. 8,613,653 B2 | A63F9/00 | 2013 Dec. 24 | Hughes |
| U.S. Pat. No. 5,727,786 A1 | 273/269,274 | 1998 Apr. 17 | Weingardt |
| U.S. Pat. No. 5,269,523 A | A63F3/065 | 1992 Aug. 19 | Boylan |
| U.S. Pat. No. 5,536,016 A | 273/269,274 | 1994 Apr. 17 | Thompson |
| U.S. Pat. No. 6,702,668 B2 | A63F3/65 | 2001 Jan. 24 | Banyai |
| U.S. Pat. No. 6,331,143 B1 | G07F17/329 | 2001 Dec. 18 | Yoseloff |
| U.S. Pat. No. 6,599,188 B2 | G07F17/3244 | 2001 Jan. 17 | Hirsch |
| U.S. Pat. No. 7,186,180 B2 | G07F17/3248 | 2003 Sep. 23 | Lathrop |
| U.S. Pat. No. 7,204,756 B2 | G07F17/329 | 2003 Sep. 23 | Jubinville |
| U.S. Pat. No. 8,795,054 B2 | G07F17/32 | 2014 Aug. 05 | Bozeman |
| U.S. Pat. No. 7,666,082 B2 | G07F17/3223 | 2010 Feb. 23 | Kane |
| U.S. Pat. No. 9,067,131 B2 | G07F17/3244 | 2015 Jun. 30 | Colvin |
| U.S. Pat. No. 9,679,442 B2 | G07F17/326 | 2017 Jun. 13 | Khal |

| Publication Number | Kind Code | Publication Date | Applicant |
|---|---|---|---|
| US 20140346731 A1 | 273/139 | 2014 Nov. 27 | Rosenfeld |
| US20050278041 A1 | A63F13/795 | 2005 Dec. 15 | Bortnik |
| US 20070191102 A1 | A63F13/795 | 2007 Aug. 16 | Coliz |
| US 20090082081 A1 | G07F17/329 | 2009 Mar. 26 | Walker |
| US 20060178194 A1 | G07F17/329 | 2006 Aug. 10 | Jubinvillee |
| US 20140128147 A1 | A63F13/12 | 2014 May 8 | Cheng |
| US 20120220362 A1 | A63F9/24 | 2012 Aug. 30 | Farah |
| US 20040204224 A1 | G07F17/3286 | 2003 Apr. 9 | Finnochio |
| US 20120202571 A1 | G07F17/329 | 2012 Aug. 9 | Stanek |
| US 20060189375 A1 | G0F17/32 | 2005 Feb. 18 | Dodge |
| US 20060100008 A1 | G0F17/32 | 2005 Dec. 21 | Wright |
| US 20110281637 A1 | G0F17/329 | 2011 May 11 | Meyer |
| US 20150031435 A1 | A63F3/0645 | 2015 Jan. 29 | Colvin |
| US 20150011288 A1 | A63F3/0645 | 2015 Jan. 8 | Colvin |
| US20150011289 A1 | A63F3/0645 | 2015 Jan. 8 | Colvin |
| US 20170053473 A1 | G07F17/329 | 2017 Feb. 23 | Colvin |

| Foreign Doc. Number | Country Code | Kind Code | Pub. Date | Applicant |
|---|---|---|---|---|
| WO 2014201491 A1 | PCT/AU | G07F17/3227 | 2014 Dec. 24 | Susman |
| WO 2010015039 A1 | PCT/AU | G07F17/3227 | 2010 Feb. 11 | Farah |
| WO 2005020161 A2 | | A63F9/24 A63F13/00 | 2005 Mar. 3 | Cannon |
| WO 2003022381 A1 | | A63F9/24 G07F17/32 | 2003 Mar. 20 | Roberts |
| WO 2006074156 A3 | | A63F3/06 | 2006 Oct. 24 | Kane |
| WO 2007044785 A3 | | A63F9/24 | 2007 Aug. 2 | Hardy |
| WO 2009002948 A4 | | A63F9/24 | 2009 Nov. 19 | Bozeman |
| WO 2006041626 A2 | | G07F17/3276 | 2006 Apr. 20 | Bozeman |

### Non-Patent Literature Documents

Hooiser lottery often pulls plug on high dollar scratch-off games before all prizes can be won, Apr. 6, 2018 Lottery Post
Mass. Lottery ends some scratch ticket games before grand prizes paid out, Nov. 29, 2017. Lottery Post
Idaho Lottery announces St. Patrick's Day Raffle winners, Apr. 13, 2017 Lottery Post
Lawsuit claims Illinois Lottery manager of fraud in instant games, Feb. 8, 2017 Lottery Post
Florida store employee arrested for micro-scratching lottery tickets, Jan. 6, 2017 Lottery Post
New York State Lottery commits fraud in sales of scratch off games, Feb. 4, 2016 Lottery Post
Cheated lottery winner files lawsuit, May 31, 2011 Lottery Post
Lotterypost.com, Lottery Post
calottery.com, California lottery
nmlottery.com, New Mexico lottery
arizonalottery.com, Arizona lottery
tnlottery.com, Tennessee lottery
ohiolottery.com, Ohio lottery
ialottery.com, Iowa Lottery
mnlottery.com Minnesota Lottery
flalottery.com, Florida Lottery
hooiserlottery.com, Indiana lottery
palottery.state.pa.us, Pennsylvania Lottery
njlottery.com, New Jersey Lottery
txlottery.org, Texas lottery
molottery.com, Missouri Lottery
kylottery.com, Kentucky lottery
mygalottery.com, Georgia Lottery
oregonlottery.com, Oregon Lottery
idaholottery.com, Idaho Lottery
nylottery.ny.gov, New York lottery
naspl.org, North American Association of State and Provincial Lotteries
scientificgames.com, Scientific Games
gtech.com, Gtech Lottery
gamingarts.com, Gaming Arts

The present invention relates to playing themed tournament games using variations of number match game types comprising; raffle bingo, keno, lotto, and lottery. Number match game types are well known in the gaming industry.

The American version of bingo is played using bingo cards having a 5×5 matrix with the letters B, I, N, G, and O printed across the top. Each card has 24 randomly selected playing symbols from the set of 75 playing symbols numbered and lettered B 1-15, I 16-30, N 31-45, G 47-60, and O 61-75 with a free space in the center. Playing symbols are drawn until a specific pattern is achieved.

Several variations are played of the standard bingo that uses seventy-five numbers and a five-by-five matrix bingo card. One variation is a 3-by-3 matrix bingo card with or without a free space. Another variation is known as Lightning Bingo or Speed Bingo and is quite popular in Indian reservations. In Lightning or Speed Bingo, there is a pool of thirty numbers, e.g. balls numbered 1-30 without letter designations. Each player has a bingo card with only three numbers thereon, generally set out in a horizontal pattern. In Lightning Bingo, the caller draws numbers sequentially from the pool of thirty numbers and a player wins when he achieves all three numbers called on his bingo card.

In one type of bingo game known as Bonanza Bingo, the draw for the game takes place before the players know the arrangements on their bingo cards. After the draw occurs, the players may purchase cards and compare the arrangements on the cards to the drawn numbers to determine whether predetermined patterns are matched. Play continues in Bonanza Bingo until at least one of the players matches a designated game-winning pattern. Bonanza Bingo may also encompass bingo variations wherein a partial draw is conducted for some numbers (generally fewer than the number of balls expected to be necessary to win the game) prior to selling the bingo cards. After the bingo cards are sold, additional numbers are drawn until there is a winner.

Another type of bingo game is listed as U.S. Pat. No. 5,727,786 which is directed to a bingo game in which the bingo numbers are color-coded. In the preferred embodiment, the seventy-five bingo ball numbers are divided into four or more groups of colored spaces, with a player having the ability to achieve a higher payout by achieving a bingo based all on one color and the highest payout by achieving a single-color bingo where the color achieved is that represented by the fewest number of bingo balls.

The European version of bingo is played using bingo cards having a 3×9 matrix. Each card has 15 randomly selected playing symbols from the set of playing symbols numbered 1-90 with each row having five playing symbols each. Playing symbols are drawn until a specific pattern is achieved.

Keno is played using cards, tickets or screens having and 8×10 matrix with playing symbols numbered 1-80. Players randomly select a predetermined amount of numbers from the set of 80 numbers, usually between I to 10 numbers. The keno game randomly or pseudo randomly selects 20 winning numbers from the set of 80 numbers. The keno game compares the player selected numbers to the randomly selected winning numbers to determine the number of matches on each ticket, card, or machine.

There are two ways to bet traditional keno tickets, straight and way. Alternative ways to bet keno include a top/bottom selection where the player bets that the ball distribution will be uneven between the numbers 1-40 (bottom) and 41-80 (top). The betting often starts paying when the distribution is uneven on a 7/13 or 13/7 ball distribution between the top half and bottom half. Higher payouts go to higher distribution inequities. Other distribution bets include left and right (as viewed on the betting card), and odd-even. There is other card geometry type of distribution bets which include edge and square Another way to bet keno is described in patent application US20140346731AI to Rosenfeld. Rosenfeld offers an additional bet to the game of Keno. The last ball drawn is used as a basis for betting (and is usually designated by a blinking number). The blinking number signifies that the current game has ended. The player may bet in one or more of any one of five ways on the last drawn ball: the exact number, whether it is top half or lower half, which quadrant it falls in: lowest, mid low, mid high, or highest; whether it is odd or even, or the last number of the last number. Other side bets are possible, such as a range of numbers, and the bets listed are not the only ones.

Various keno games have been developed including one to Weingardt U.S. Pat. No. 5,909,875, where an electronic random number generator is used to select a predetermined group of keno numbers to be “red” numbers for that game. All the other remaining keno numbers are “white” numbers for that game of keno. When a player achieves a winning keno ticket, the player wins certain pre-established payouts depending upon whether the player has an all “red” keno winning combination, an all “white” winning keno combination or a “mixed color” winning keno combination.

The number match game U.S. Pat. No. 6,702,668 B2 issued to Banyai is like keno and bingo but, with significant departures multiple drawings of playing symbols. Another number match game, WO 2005020161 A2 issued to Cannon describes variations of keno, bingo, and lotto games having a sequential display of playing symbols and where the playing symbols are weighted.

Various types of bingo games may use different types of progressive prizes. The first involves increasing a prize amount based on contributing a portion (either fixed amount or percentage) of each ticket sold to the progressive prize pool. Some progressive prize pools are increased per unit of time, such as a day, week, etc. Progressive prize pools may be grouped in different ways, including by winning pattern, days of the week, bingo session (time of day), etc. Some progressive prize games may change the contribution amount after the game starts and/or stop contributions once the prize reaches a certain value.

In virtually all keno, lottery, bingo, and slot machines, the progressive portion of the prize is split when there are multiple winners. The progressive portion is the current amount of the progressive meter less the amount of the base jackpot. The progressive portion grows by allocating a portion of every wager to the progressive meter. Thus, when there are multiple winners, the progressive amount is generally split evenly among all winners. For example, a game starts with a base jackpot of $10,000. As players make wagers, a portion of each wager is added to the progressive meter causing it to grow to $14,000. If two people were to win the progressive jackpot or prize during the same game, they would each be paid the base amount of $10,000 in addition to half of the progressive amount of $4,000 for a total prize award of $12,000. Additionally, in many instances the progressive prize is paid on an aggregate basis and would be split evenly among the winners for $7,000 each in this example.

The various styles of bingo and related games generally have some common features. For example, a game (i.e. winning criterion) ends when the first winner satisfies the winning criterion. In combined games, play may continue after a first winner has been identified, but the winning criterion and/or prize are changed for a second or subsequent winner. For example, a group of player selected numbers is matched first, and the game play is continued to match one or more patterns, such as a single line followed by double line, or a double line followed by a coverall. Similarly, because many jurisdictions require bingo and related games to be played to conclusion (in contrast to keno or lotto type games where it is acceptable to not have a winner), if there is no winner matching the winning criterion within the required number of calls, the winning criterion and/or prize may be changed for a consolation game that is played until a winner is determined, for example. Another common feature of the various games, including keno, lotto, and progressive style games, is that multiple winners generally split or share the prize.

The basic version of lotto lottery is played using numbers from 1 to 49. A player chooses six numbers from 1 to 49. Six numbers are drawn plus a bonus number, out of 49 numbered balls. If a player matches all 6 numbers, they win the jackpot. If they match 5 numbers and the bonus number, they win the second highest prize. If they match five, four or three numbers, they can win smaller prizes

Powerball® is a lottery game with a combined large jackpot game and a cash game. Each ticket costs $2. The gaming authority draws five white balls out of a drum with 69 numbered white balls and one red ball out of a drum with 26 numbered red balls. Players win by matching one of nine possible winning combinations. The jackpot is won by matching all five white balls in any order and the red Powerball®. The second cash prize is won by matching five white balls in any order. A player also wins a cash prize any time they match the red Powerball®.

Instant win lottery tickets are based upon the premise that a certain number of tickets are going to win of all the tickets produced. This means of determining odds is only effective if all of the tickets produced are sold and winning and losing tickets are distributed evenly throughout the system. The authorities running the system can never be sure how many tickets will be sold or whether winning tickets are proportionately distributed with losers. Because of this, the player can never be sure exactly what his chances are. Printed tickets are capable of being forged, stolen, lost, or even misprinted, which recently occurred on a grand scale in New York State, all of which reveals the frailty of such systems, and ultimately, is manifested in player discontent.

“Scratch-off’ or “instant-win” lottery tickets have enjoyed immense popularity in the lottery industry for decades. One patent U.S. Pat. No. 8,221,213 B2 issued to Martineck discloses an instant-win lottery game system is provided that includes a plurality of instant-win lottery tickets, with each ticket having a play area with a plurality of play spaces arranged in defined pattern.

Another patent for instant win games U.S. Pat. No. 7,883,405 B2 issued to Robb discloses the invention is directed to a method of conducting an instant win game in combination with a base wagering game. The method may include receiving a base wagering game entry and a base wagering game wager from a player and receiving an instant win game wager from the player. The method may further include storing a game theme indicator, storing a plurality of instant win game outcome display themes, and determining an outcome of the instant win game for the player.

The patent WO 2003022381AI issued to Roberts describes a way to play an instant win lottery gaming system and then utilizing the internet to access a secondary game. Another patent WO 2006074156A3 issued to Kane describes for one embodiment, the offline portion of the game permits the player to progress through the game without revealing a final outcome. In another example, the offline portion of the game is configured to provide a partial outcome indicative of a possible win. This outcome indicative of a possible win may include an indication that the player is close to winning within a particular game instance. For example, in the case of a bingo game, the offline portion of the game may provide an indication that the player is close to obtaining a winning bingo pattern. This indication entices the player to continue to play the online portion of the game to obtain the final outcome of the game.

Tournaments for games like poker, slots, bingo, keno, and baccarat are based on the outcomes from the games of chance. For example, in a slot tournament, each player's slot machine is loaded with a predetermined starting bankroll. A tournament session is conducted in which all players simultaneously play the slot machines, with winnings being credited to the bankroll and losses being deducted from the bankroll. The winner is determined by comparing the final bankrolls of the players. The player who had the greatest net difference between his winning outcomes and losing outcomes, i.e. the player who had the greatest net winnings, is the winner. The World Series of Poker has a buy-in of $10,000 dollars and last for a couple of months. The winners are ranked according to how long they lasted in the tournament, a knock out tournament. Bingo tournaments conducted in Las Vegas require a significate buy-in to play and usually last a couple of days. Multiple games are scheduled for each event. The winning player is the first player who obtains an outcome on his or her bingo card that matches a predefined pattern. Thus, the winner of the bingo “tournament” is the player who obtains a winning game outcome during the game with the grand prize.

A patent directed towards tournament games, U.S. Pat. No. 6,039,648, issued to Guinn et al., describes an apparatus and method for an automated tournament gaming system utilizing a computer network coupled to several gaming machines. The Guinn patent also provides for a multi-site progressive automated tournament where a central server computer is coupled to a tournament schedule computer.

Some patent U.S. Pat. No. 8,512,119 B2, U.S. Pat. No. 8,523,650B2, and U.S. Pat. No. 8,678,902B2, issued to Kelly describes in one embodiment, a gaming system for presenting tournament games includes a plurality of gaming devices in communication with a tournament server as well as a plurality of tournament displays positioned throughout a gaming establishment. Kelly discloses that players without player cards cannot play in a weekly tournament or participate in a raffle.

The patent WO 2007044785 A3 issued to Hardy describes a method for conducting a game tournament where the primary game result is driven by the result of a secondary game, such as a lottery or casino-based drawing (e.g., a Keno drawing). The secondary game is then played, and the result of the overall tournament is determined based on the results of the secondary game instances. Results of the secondary game instances and the result of the tournament are sent to an online gaming system. The player is then permitted to play an online game to reveal the results of the secondary game instances and the result of the overall tournament.

The U.S. Pat. No. 6,309,299 B1 issued to Weiss discloses a gaming device which allows individual play, head to head play and tournament play and involves the utilization of at least three chance means, including a plurality of reels, a video display configured as a matrix upon which scores can accumulate and icons located upon the grid itself provided for additional scoring. Tournament winners can be determined by weighing nautical performance, keno results and reel outcomes all as a function of time played and credits aggregated.

The application U.S.20030060264 A1 by Chilton discloses a slot gaming device having a set of reels and a plurality of symbols on the reels. At least one of the symbols or a combination of symbols is a tournament qualification symbol or a tournament qualifying combination, respectively. A player spins the reels in a conventional manner. If, when the reels stop spinning, the qualification symbol or combination is displayed, and thus, the player obtains a tournament qualifying outcome on an active pay line, the player receives a tournament entry.

Another application, U.S. 20120220362 A1 by Farah describes a method to play a lottery tournament using an algorithm and gaming tokens, the value and form of the gaming token depends on the game that is being utilized by the lottery tournament. In one example, the game is Rock/Paper/Scissors and the gaming token corresponds to one of rock, paper, and scissors, being a limited number of selectable or assignable tokens. In another example, the token is a 3×3 sized table of single digit integer values (i.e. 0-9), giving 9! (=362880) number of possible combinations for a table. A (first) participant populates a table for game play of the first participant, and a second table as an attempt to match the game play of another participant. Those two tables form a “token” in the game. A (second) participant does the same, and the four tables are cross-matched to numerically determine a winner between the two participants. Essentially, the participant whose second table best matches the game table of the other participant, is the winner. A predetermined algorithm may assess the level or degree of match to give a matching score for the participant, which is then compared with the matching score of the other participant.

Another patent, U.S. Pat. No. 6,224,486 issued to Walker, describes a distributed electronic tournament system that allows remotely located players to be identified via a player tracking system, and allows the identified players to participate in tournaments such as chess, bridge, computer golf games, poker, and the like from their homes. In addition to player tracking, a database, maintained at a central location, enables registration of players, acceptance of entry fees, and coordination of prize money.

Several patents including, U.S. Pat. No. 8,702,499B2 and U.S. Pat. No. 8,894,480B2 to Johnson, U.S. Pat. No. 8,690,661 to Cannon, U.S. Pat. No. 7,798,901B2 to Nguyen, U.S. Pat. No. 8,702,52082 to Seelig, and U.S. Pat. No. 9,123,205B2 to Weingardt disclose methods to play a tournament game using gaming devices in communication with a tournament server.

Traditionally, raffles are events that raise funds (e.g., for charities, governments, etc.) and long predate online computer technology. Players purchase tickets with unique identifiers. Identifiers are randomly selected from the pool of those purchased and prizes are awarded. Online raffles simply expand on their old-fashioned counterparts by allowing broader participation and larger prizes, made possible by computer technology

One way to play a lottery raffle game is described in WO 2009002948 A4 by Bozeman. In a single-wheel embodiment, a player selects a letter from the alphabet. The lottery extends this selection to a unique raffle identifier, which is memorialized on a paper ticket. The first stage of the game is the spinning of the “raffle wheel,” which comprises slots occupied by letters of the alphabet interspersed with prizes. If the outcome is a letter, a group of players is simultaneously awarded prizes, i.e., entries for which players selected the winning letter each receive a prize. Otherwise, the outcome of the first stage of the drawing is a prize, from which follows a second stage to the drawing: an individual raffle drawing for the winner of this prize.

A patent for playing a lottery raffle issued to Bozeman, U.S.7,213,811 B2 discloses a method which includes the steps of playing a base game and receiving a base game entry, electing to play a second lottery game in addition to the base game and selecting game indicia for said second game, selecting a winning entry for the base game, assigning winning game indicia for the second game to be the game indicia selected for the second game on the winning base game entry, comparing said winning game indicia to the game indicia of additional base game entrants that elected to play the second game so that winners of the second game are determined based on matches with the indicia for the second game on the winning base game entry, and awarding prizes to winners of the base game only, the second game only, and both the base game and the second game.

In another embodiment of U.S. Pat. No. 7,213,811 B2, there is provided another method for playing a lottery game. The method includes receiving a set of selected digits for an extension game from a player, issuing a game ticket with set of selected digits for a base game to the player, selecting a winning ticket for the base game, determining selected digits associated with the winning ticket, and determining a prize for each game ticket having the selected digits.

Another way to play a lottery raffle game is described in U.S. Pat. No. 8,480,470 B2 to Napolitano. The embodiments combined instant win lottery tickets with raffle games. These instant win ticket games may provide conventional instant win cash prizes. In addition, some of the tickets in the game may also award a free entry into a raffle game that is to be held later. The tickets awarding the free raffle entries may include a special symbol or combination of symbols indicating that the ticket holder has won a raffle chance. These raffle chance winning tickets may be presented for redemption, and a raffle ticket issued for a future raffle drawing.

Still another lottery raffle game is described in U.S. Pat. No. 8,613,653B2 by Hughes. Hughes explains a progressive raffle add-on game that is added to a base game of chance where the outcome is partially determined by the player placed upon playing the base game play.

The patent application WO 2014201491AI to Susman discloses a computer-implemented method of determining a winner of a lottery, including: generating data relating to tickets purchased by users, said data including, for each ticket, a value for each of one or more variables and a status indicator indicating whether the ticket is live or dead;

In recent years, several state lotteries have incorporated a raffle on an annual or semi-annual basis. One of the most popular state raffles is named the Millionaire Raffle and offers players the best odds to win $1 million dollars, where sponsoring states offer a limited number of raffle tickets at an average price of $20 per ticket. Each ticket contains one unique number which is included in a raffle drawing.

The North American Association of State and Provincial Lotteries stated that lotteries took in 70.1 billion in sales in the 2014 fiscal year. To meet consumer demands, both lotteries and their service providers (e.g., Scientific Games, GTECH, Pollard Banknote, Intralot, etc.) are searching for and developing new forms of gaming and gaming content. These publicly traded firms oversee much of the development, algorithm design, and production of the different gambling games, and the state lotteries are largely dependent on their expertise.

Therefore, it is desirable to provide new and innovate number match games that not only provide the opportunity for a player to win competitive prizes, but also provide entertainment value with a variety of themed tournament games which are quick, secure, easy to learn and fun to play.

### SUMMARY

The prior art disclosures are heretofore known to suffer from several disadvantages comprising;
live tournaments are costly, time consuming and require operators to dedicate resources to conduct them.
live tournaments require player participation, meaning that the player be present at the time of the tournament, which limits participation.
Many live tournaments are conducted using a fixed number of gaming machines which limit participation.
Instant win scratchers require expensive security measures to print and distribute making the games costly to produce and difficult to shut down.
Second chance raffle games require players to fill out tickets with personal information and then mail them into the lottery authority.
Lottery ticket printers have become increasingly worried about forensic breaking, the possibility of criminals using sophisticated imaging technology to see underneath the latex. The “breakability” of tickets is a constant concern. The printers have also become concerned about the barcodes on the tickets, since the data often contains information about payouts.

### Advantages

Accordingly, several advantages are to provide dynamic themed raffle tournament games that can reduce the costs required to operate the tournament, reduce the time needed to conduct the tournament and improve the odds to win.

The advantages of the raffle tournament game design permit the operator to;
use different number match game types, pay tables, and ticket prices to target specific players in specific markets.
use a variety of themes with different types of tournament values to create fun and exciting tournament games.
use sequentially numbered raffle arrays to create similar odds to win like instant win lottery tickets.
use electronic copies of sequentially numbered raffle arrays to conduct fast, secure, and efficient tournament games
use a computer system to issue tickets with raffle arrays in sequential order
use a computer system to identify tickets with specific matches and specific rankings and to record, verify and display the results of the tournament games
arrange tournament events for raffle arrays matching a predetermined number of event codes, each event code having a predetermined number of place values based on the total number of tickets dispensed to players, which gives the operator the ability to adjust the odds to win for each raffle tournament game.

### BRIEF DESCRIPTION OF THE DRAWINGS

FIG. 1 shows parts of the flowchart for the raffle tournament game.

FIG. 1A shows the rest of the flowchart for the raffle tournament game.

FIG. 2, shows some of the elements used to design the raffle tournament game embodiments.

FIG. 3 shows some of the possible playing symbols used to play the raffle tournament game.

FIG. 4 shows the drawings of two different embodiments of the raffle tournament game.

FIG. 4 A shows the drawings of two different embodiments of the raffle tournament game.

FIG. 5 shows the drawing of an event code for five different embodiments.

FIG. 6 shows a ticket for one keno embodiment of the raffle tournament game.

FIG. 6 A shows a tournament event for one of the event codes selected.

FIG. 7 shows a ticket for one lotto, lottery embodiment of the raffle tournament game.

FIG. 7 A shows a tournament event for one of the event codes selected.

FIG. 8 shows a ticket for one bingo embodiment of the raffle tournament game.

FIG. 8 A shows a tournament event for one of the event codes selected.

FIG. 9 shows a ticket for one raffle embodiment of the raffle tournament game.

FIG. 9 A shows a tournament event for one of the event codes selected.

FIG. 10 shows multiple tournament events for an event code.

FIG. 10 A shows a final tournament event for one embodiment of the raffle tournament game.

FIG. 11 shows the prize board for a keno embodiment of the raffle tournament game.

FIG. 12 shows the prize board for a bingo embodiment of the raffle tournament game.

FIG. 13 shows the prize board for a raffle embodiment of the raffle tournament game.

FIG. 14 shows the prize board for a lotto, lottery embodiment of the raffle tournament game.

FIG. 15 shows the flowchart for one possible computer system.

### REFERENCE NUMERALS

16. Operator
17. Vendor(s)
18. Player(s)
19. Game design
20. Tournament game
21. Number match game
22. Bingo game board
23. Keno game board
24. Lotto, Lottery game board
25. Raffle game board
26. Playing symbol(s)
27. Draw(s) Drawing
28. Match(es)
30. Ticket(s)
31. Rules
32. Title
34. Game data
36. Picks to win
38. Raffle Array(s)
39. Bar Code
40. Tournament Event(s)
42. Tournament board(s)
44. Tournament Event Identifier
46. Event Code(s)
48. Place value(s)
50. Tournament Value(s)
52. Tournament Value parameters
54. Event Slot(s)
56. Event rank
58. Tournament Standings
60. Prize board(s)
61. Prize Percentages
62. Prize(s)
64. Processor(s)
65. Program(s)
66. Memory device(s)
68. File(s)
69. Operating system
70. Computer(s)
72. Peripheral device(s)
74. Server(s)
76. Website(s)
78. Internet,
80. Computer System
82. Ticket terminal(s)
84. Kiosk(s)
86. VLT(s) video lottery terminal(s)
88. Gaming machine(s)
90. Microprocessor devices
91. Wager(s)
92. Complimentary Wager(s)

### DETAILED DESCRIPTION

Reference will now be made in detail to embodiments of the invention, one or more examples of which are illustrated in the figures. Each example is provided by way of explanation of the invention, and not meant as a limitation of the invention. It is intended that the present invention include design modifications and variations.

It will be appreciated that all the disclosed methods, games, and procedures described herein can be implemented using one or more computer programs or components in the computer system. These components may be provided as a series of computer instructions on any conventional computer readable medium, including RAM, ROM, flash memory, magnetic or optical disks, optical memory, or other storage media. The instructions may be configured to be executed by a processor which, when executing the series of computer instructions, performs, or facilitates the performance of all or part of the disclosed methods, games, and procedures.

Reference throughout this specification to “match, matches, matched, matching” means to be exactly like one another, to have playing symbols which correspond exactly. Reference throughout this specification to “raffle array(s)” means a unique arrangement of playing symbols used to identify tickets dispensed sequentially to players. Reference throughout this specification to “event code(s)” means to be a randomly drawn arrangement of a predetermined number of playing symbols used to arrange tournament events. The number and length of event code(s) are based on the total number of tickets dispensed to players. Reference throughout this specification to “tournament event” means to be a contest between a predetermined number of players. Reference throughout this specification to “event slot(s)” means an assigned place for raffle arrays in the tournament event. Reference throughout this specification to “event rank” means to have a relative position with a degree of value in the tournament event. Reference throughout this specification to “tournament value(s)” means to be an assigned degree of measurement in order to compare against for the contest. Reference throughout this specification to “place values” means to have a value given to a digit by virtue of its location in a numeral. Reference throughout this specification to “draw, draws, drawing” means to randomly select a predetermined number of playing symbols from the set of playing symbols. Reference throughout this specification to computer system means a collection of elements or components comprising; processors, programs, memory devices, files, computers, operating systems, peripheral devices, servers, websites, and internet, that are organized to operate the raffle tournament game. Reference throughout this specification to microprocessor devices means any device having a CPU processor comprising; smartphones, desktops, laptops, tablets, and similar devices used to send and receive information.

Objects and advantages of the invention will be set forth in part in the following description, or may be obvious from the description, or may be learned through practice of the invention.

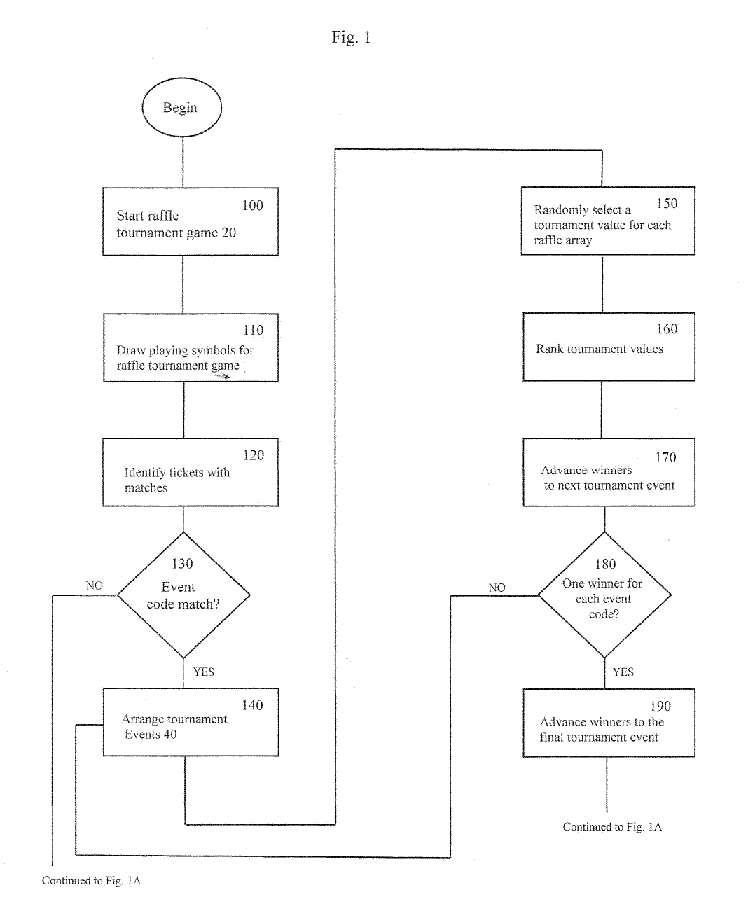

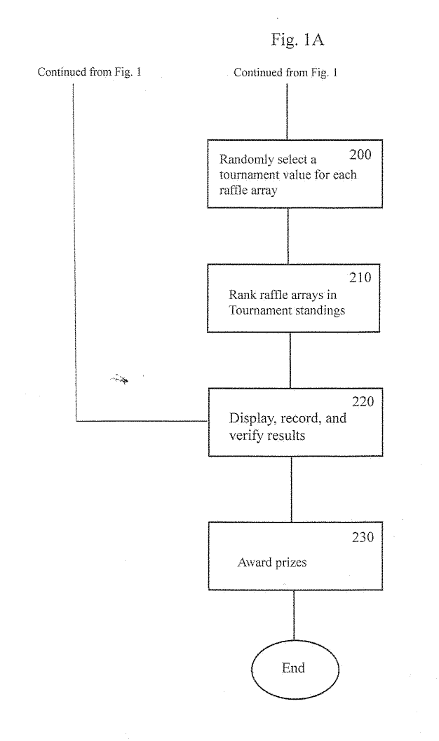

The flow chart on FIG. 1 shows the steps taken to conduct the raffle tournament game 20. In step 100, the operator 16 starts the raffle tournament game 20, from hereonout referred to as “RTG”. The operator 16 in conjunction with the vendor(s) 17 promotes, offers, and sells the tickets 30 to players 18. The operator 16 uses the computer system 80 to issue the tickets 30 with ticket arrays 38 in sequential order to players 18 making a wager 91 or a complimentary wager 92. Preferably, the operator 16 can use multiple components comprising; numbers, numerals, letters, symbols, and colors, with the ticket arrays 38 to create more opportunities to win prizes 62.

In step 110, the operator 16 stops the sale of tickets 30 at a predetermined time. The operator 16 uses the total number of tickets 30 dispensed to players 18 to determine the number of places values 48 to use for each event code 46 and the number of event codes 46 to use for the RTG 20. The operator 16 makes a copy of every ticket 30 that was sold or distributed and stores them in memory devices 66 on computers 70. The operator 16 draws playing symbols 26 from the set of playing symbols for the RTG 20. The results of the drawing 27 are recorded and stored in memory devices 66.

In step 120, the operator 16 analyzes the tickets 30 stored in memory devices 66 and identifies tickets 30 with matches 28. The operator further analyzes the tickets in step 130.

In step 130, the operator 16 determines if the tickets 30 match 28 an event code 46. If the tickets 30 do not match 28 an event code 46, then the operator 16 proceeds to step 220 where the tickets 30 with matches 28 are recorded, verified, and displayed. If the tickets 30 match 28 an event code 46, the operator then proceeds to step 140.

In step 140, the operator 16 arranges tournament events 40 for the tickets 30 matching the predetermined number of event codes 46. The operator 16 selects a predetermined number of event slots 54 for each tournament event 40. The operator 16 uses copies of the tickets raffle arrays and sequentially places the raffle arrays 38 into event slots 54 on the tournament board 42.

In step 150, for each tournament event 40, the operator 16 randomly selects a tournament value 50 for each ticket array 38. For some embodiments, multiple tournament values can be selected for each ticket 30. In which case, the tournament values 50 would have to be added together to achieve one tournament value 50 to rank on the tournament board 42. Preferably, the operator 16 can use multiple components comprising; numbers, numerals, letters, symbols, and colors, with the tournament values 50 to create more opportunities to win prizes 62.

In step 160, for each tournament event 40, the operator 16 ranks the tournament values 50 and places each ticket 30 into an event rank 56 located on the tournament board 42. The method to rank the tournament values 50 depends on the rules 31 and the tournament value parameters 52

In step 170 the operator 16 advances the winners of each tournament event 40. The number of tickets 30 dispensed to players 18 determines the number of tournament events 40 required to achieve one winner for each event code 46.

In step 180, the operator 16 determines if there is one winner for each event code 46. If there is more than one winner, then the operator 16 returns to step 140 to arrange another round of tournament events 40. If there is one winner for each event code 46 then the operator 16 proceeds to step 190

In step 190, the operator 16 advances the winners to a final tournament event 40. For the final tournament event 40, the operator 16 arranges copies of each ticket 30 according to the sequential order of the raffle arrays 38.

In step 200, the operator 16 randomly selects a tournament value 50 for each raffle array 38. For some embodiments, multiple tournament values can be selected for each ticket 30. In which case, the tournament values 50 would have to be added together to achieve one tournament value 50 to rank.

In step 210, the operator 16 ranks the tournament values 50 and places each ticket 30 into an event rank 56 on the tournament standings 58. The method to rank the tournament values 50 depends on the rules 31 and the tournament value parameters 52

In step 220, the operator 16 displays the results of the RTG 20 on the prize board 60. The operator records and verifies the results of the RTG 20 using the computer system 80.

In step 230, the operator 16 awards prizes 62 to players 18 having a specific match. The amount of the prize 62 is determined by the allocation of funds for each type of match 28. The operator 16 awards prizes 62 to players 18 having a specific ranking in the tournament standings 58. The amount of the prize 62 is based on the prize percentage 61 of the total amount of funds allocated for the final tournament event 50.

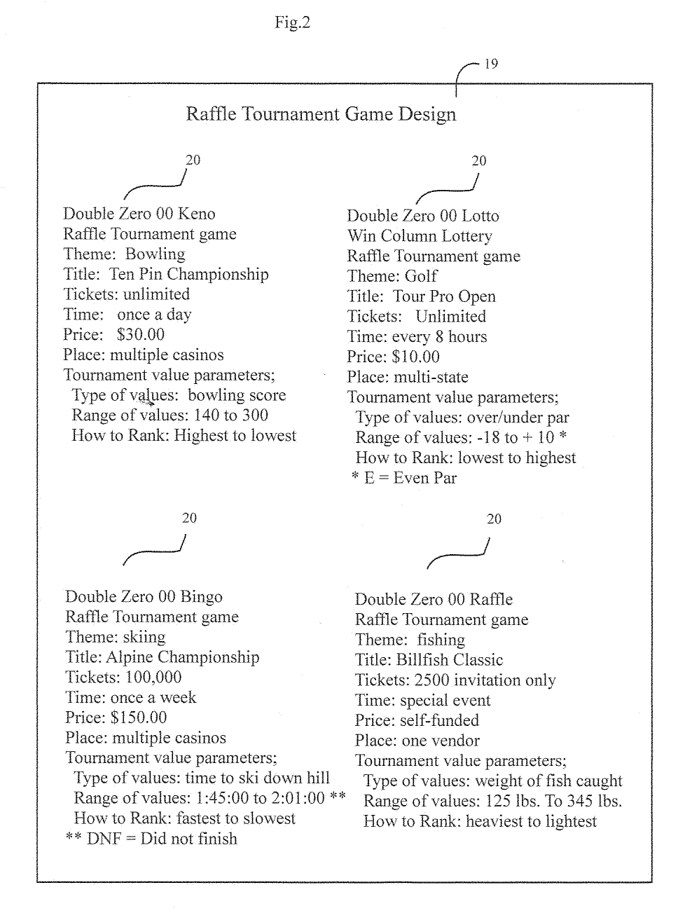

Shown in FIG. 2 are certain design elements for the RTG 20. The operator 16 in collaboration with vendor(s) 17 use marketing mix strategies of product, price, promotion, and place to design games to entice players 18 to play. The game design 19 shows different themes. number match games. ticket prices, game length, and distribution channels used to attract the players 18 for specific target markets. The tournament value parameters; type of value, range of values and how to rank values are designed to correspond to the theme used for the RTG 20.

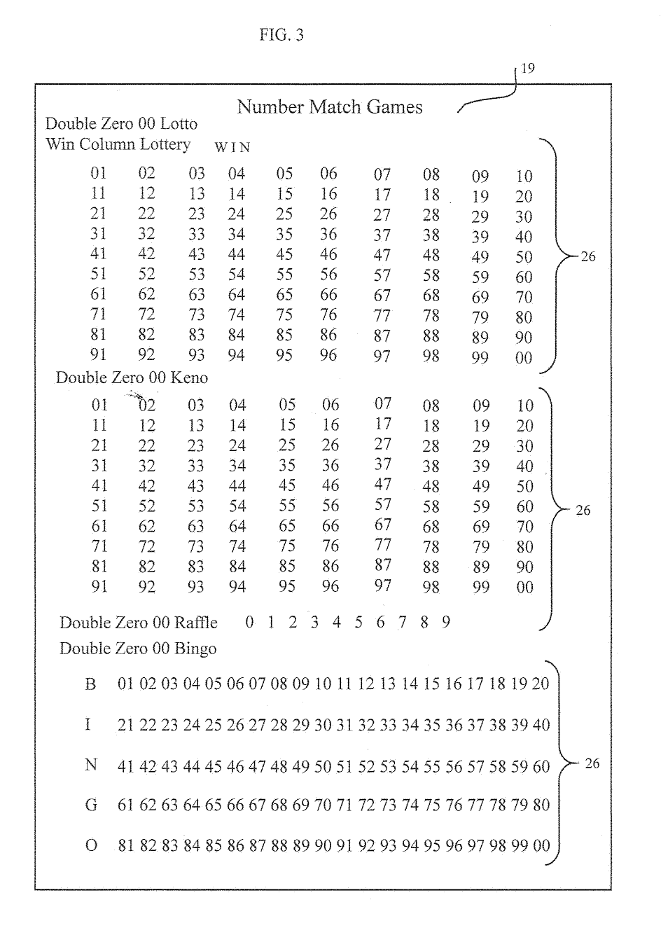

Shown in FIG. 3 are five different number match game 21 embodiments and their playing symbols 26 used to play the RTG 20. The win column lottery embodiment shows the playing symbols 26, numbers 01 to 00. with 00 being 100 and letters W.I.N. The lettered playing symbols 26 are used to identify a specific column in which the numbered playing symbol(s) 26 are selected. The double zero lotto embodiment shows the playing symbols 26 numbers 01 to 00 with 00 being 100. The double zero keno and the double zero raffle embodiments show the playing symbols 26 numbers 01 to 00 with 00 being 100. The double zero raffle embodiment also uses the playing symbols 26 numbers O to 9. The double zero bingo embodiment shows the playing symbols 26 numbered letters B 1 to 20, 1 21 to 40, N 41 to 60. G 61 to 80, and 0 81 to 00 with 00 being 100 and lettered playing symbols and O. The lettered playing symbols 26 are used to identify a specific column and a specific row in which the numbered letters are selected. The game design 19 of these embodiments with playing symbols 01 to 00 with 00 being 100 allows the operator 16 to use the last two digits of each raffle array 38 to match 28 the playing symbols selected for the number match game 21. The game design 19 gives the operator 16 the ability to produce odds to win similar to instant win lottery games.

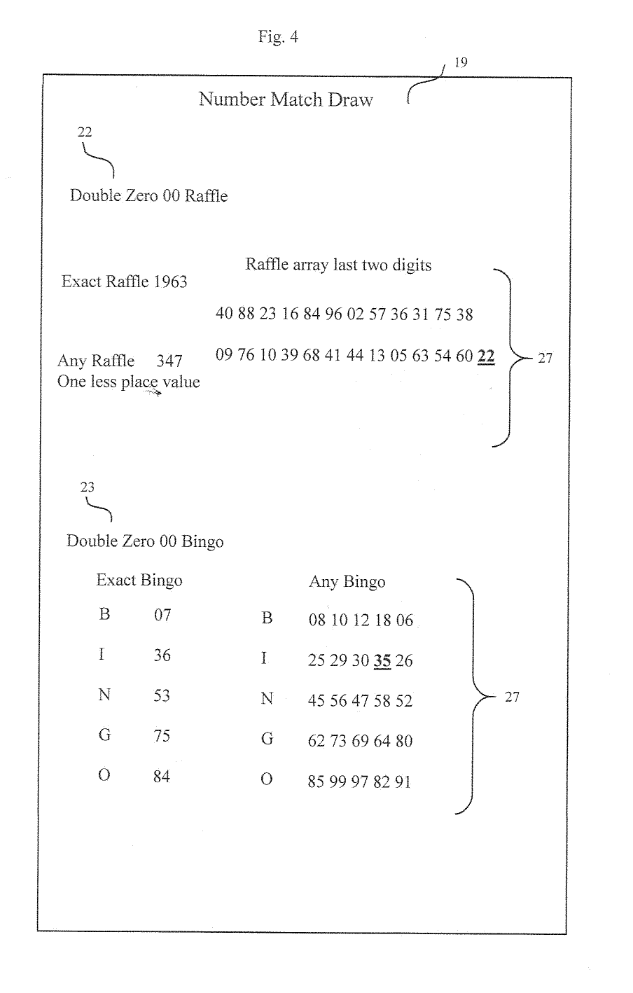

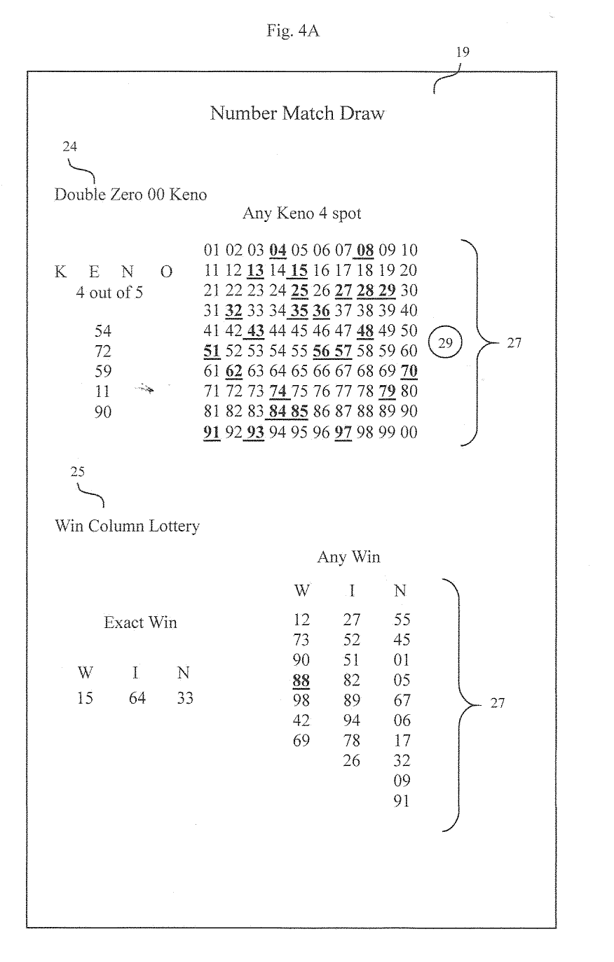

The game design 19 in FIG. 4 shows two number match games 21 used to play the RTG 20. The first raffle game board 22 shows four drawings 27 for the double zero raffle game. The first drawing 27 shows the selection of a four-digit raffle array 1963. The first three numbers 9, 6, 3 are selected from the set of numbers O to 9, with the fourth and final number selected from a set of numbers O and 1. If the third number selected was less than five, then the set of numbers for the fourth number would be 0, 1, and 2, because only 2500 tickets were dispensed to players 18. Players 18 must match 28 exactly the raffle array 38 to win. The second drawing 27 shows the selection of a three-digit raffle array 347. Each number selected from the set of numbers O to 9. Players 18 win when they match 28 the last three digits of the raffle array 38. The third drawing 27 shows the selection of twenty-five numbers from the set of numbers from 01 to 00, with 00 being 100. The fourth drawing 27 shows the selection of one number 22 highlighted from the set of selected numbers from the third drawing 27. The number 22 becomes the special raffle array last two digits. The remaining 24 numbers become the raffle array last two digits. Players 18 win when the last two digits of their raffle array 38 match 28 the numbers selected.

The second bingo game board 23 shows the drawings 27 for the double zero bingo game. The first drawing 27 shows the selection of five numbered letters, B 07, 1 36, N 53, G 75 and 0 84 one numbered letter from each group of numbered letters; B 01 to 20, 1 21 to 40, N 41 to 60, G 61 to 80, and 81 to 00 with 00 being 100. Players 18 must match 28 all five numbers to win. The second drawing 27 shows the selection of five numbered letters; B 08, 10, 12, 18, 06 1 25, 29, 30, 35, 36 N 45, 56, 47, 58, 52, G 62, 73, 69, 64, 80, and O 85, 99, 97, 82, 91 from each group of numbered letters; B 01 to 20, 1 21 to 40, N 41 to 60, G 61 to 80, and O 81 to 00 with 00 being 100. Players must match 28 one numbered letter from each letter to win. The third drawing 27 shows the selection of one number 35 highlighted from the set of selected numbers from the second drawing 27. The numbered letter B 35 becomes the special raffle array last two digits. The remaining 24 lettered numbers become the raffle array last two digits. Players 18 win when the last two digits of their raffle array 38 match 28 the numbered letters selected.

The game design 19 in FIG. 4 A shows two different number match games 21 used to play the RTG 20. The first keno game board 24 shows the drawings 27 for the double zero keno game. The first drawing 27 shows the selection of five numbers, 54, 72, 59, 11, and 90 from the set of numbers 01 to 00, with 00 being 100. Players 18 must match 28 four out of the five numbers to win. The second drawing 27 shows the selection of twenty-five numbers from the set of numbers from 01 to 00, with 00 being 100. The selected numbers 4, 8, 13, 15, 25, 27, 28, 29, 32, 35, 36, 43, 48, 51, 56, 57, 62, 70, 74, 79, 84, 85, 91, 93, and 97 are underlined and highlighted. Players must match 28 four out of the twenty-five numbers to win. The third drawing 27 shows the selection of one number 29 circled from the set of selected numbers from the second drawing 27. The number 29 becomes the special raffle array last two digits. The remaining 24 numbers become the raffle array last two digits. Players 18 win when the last two digits of their raffle array 38 match 28 the numbers selected.

The second lotto, lottery game board 25 shows three different drawings 27. The first drawing 27 selects 15 for the letter W, 64 for the letter I and 33 for the letter N. Players 18 must match 28 the numbers in exact order to win. The second drawing 27 selects seven numbers 12, 73, 90, 88, 98, 42, and 69, for the letter W eight numbers 27, 52, 51, 82, 89, 94, 78, and 26 for the letter I, and ten numbers 55, 45, 01, 05, 67, 06, 17, 32, 09, and 91 for the letter N. Players 18 must match 28 one number from each letter to win. The third drawing 27 shows the selection of one number 88 highlighted from the set of selected numbers from the second drawing 27. The number 88 becomes the special raffle array last two digits. The remaining 24 numbers become the raffle array last two digits. Players 18 win when the last two digits of their raffle array 38 match 28 the numbers selected.

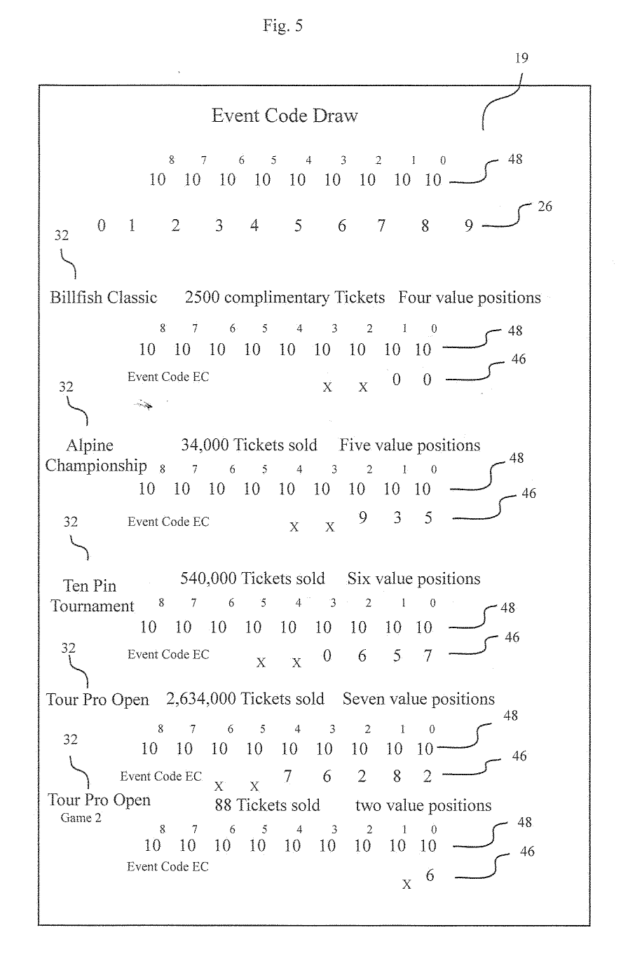

The game design 19 in FIG. 5 shows how event codes 46 from various embodiments are selected. The game design 19 selects a playing symbol 26 from the set of playing symbols O to 9 for each place value 48 required by the total number of tickets 30 dispersed to players 18 and the rules 31.

The first embodiment shows a RTG 20 with the title 32 Billfish Classic. The RTG 20 shows that 2500 tickets 30 were dispersed to players 18. The game design 19 calls for the operator 16 to select playing symbols 26 for place values 48 up to two place values 48 away from the total number of tickets 30 dispersed to players 18. Therefore, the operator 18 randomly selects an event code 46 with two digits; O for the tens place value and O for the ones place value.

The second embodiment shows a RTG 20 with the title 32 Alpine Championship. The RTG 20 shows that 34,000 tickets 30 were dispersed to players 18. The game design 19 calls for the operator 16 to select playing symbols 26 for place values 48 up to two place values 48 away from the total number of tickets 30 dispersed to players 18. Therefore, the operator 18 randomly selects an event code 46 with three digits; 9 for the hundreds place value, 3 for the tens place value and 5 for the ones place value.

The third embodiment shows a RTG 20 with the title 32 Ten Pin Championship The RTG 20 shows that 540,000 tickets 30 were dispersed to players 18. The game design 19 calls for the operator 16 to select playing symbols 26 for place values 48 up to two place values 48 away from the total number of tickets 30 dispersed to players 18. Therefore, the operator 18 randomly selects an event code 46 with four digits; O for the thousands place value, 6 for the hundreds place value, 5 for the tens place value and 7 for the ones place value.

The fourth embodiment shows a RTG 20 with the title 32 Tour Pro Open The RTG 20 shows that 2,634,000 tickets 30 were dispersed to players 18. The game design 19 calls for the operator 16 to select playing symbols 26 for place values 48 up to two place values 48 away from the total number of tickets 30 dispersed to players 18. Therefore, the operator 18 randomly selects an event code 46 with five digits; 7 for the ten thousands place value 6 for the thousands place value, 2 for the hundreds place value, 8 for the tens place value and 2 for the ones place value.

The fifth embodiment shows a RTG 20 with the title 32 Tour Pro Open game 2. The RTG 20 shows that 88 tickets 30 were dispersed to players 18. The game design 19 calls for the operator 16 to select a playing symbols 26 for one place value 48 away from the total number of tickets 30 dispersed to players 18. Therefore, the operator 18 randomly selects an event code 46 with one digit; 6 for the ones place value.

The game design 19 calls for the operator 16 to select 12 event codes 46 for each embodiment, except for the last embodiment where only 88 tickets were dispersed to players 18. The game design 19 calls for the operator 16 to select only four event codes 46 for this embodiment. The game design 19

determines that there are 25 tickets for each event code 46, 2500 divided by 100=25, for the first embodiment. The game design 19 determines that there are 34 tickets for each event code 46, 34,000 divided by 1000=34, for the second embodiment. The game design 19 determines that there are 54 tickets for each event code 46, 540,000 divided by 10,000=54, for the third embodiment. The game design 19 determines that there are 26.34 tickets for each event code 46, 2,634,000 divided by 100,000=26.34, for the fourth embodiment. The game design 19 determines that there are 8.8 tickets for each event code 46, 88 divided by 10=8.8 for the fifth embodiment.

If the game design 19 calls for the operator 16 to select playing symbols 26 for place values 48 up to three place values 48 away from the total number of tickets 30 dispersed to players 18, then the operator 16 would adjust the number of event codes 46 selected from twelve to four. The game design 19 determines that with three place values 46 away from the total number of tickets 30 dispersed there would be 250 tickets for each event code 46, 2500 divided by 10=250, instead of 25 for the first embodiment.

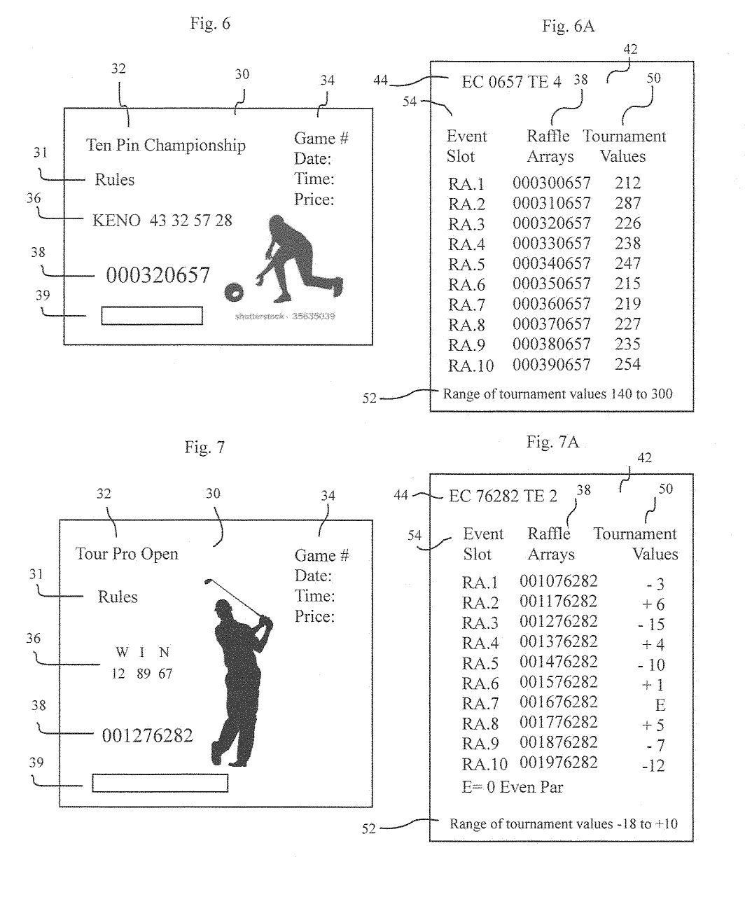

Shown in FIG. 6 is the ticket 30 of one embodiment used for the RTG 20. The ticket 30 shows the rules 31, the title 32, Ten Pin Championship, the game data, game number, date, time, and price, the picks to win 36 the keno game, the raffle array 38 and finally the bar code 39. The picks to win 36 numbers, 43, 32, 57, and 28 match 28 the numbers selected in FIG. 4 on the keno game board 24 for the four out of twenty-five. The last two digits of the raffle array 38 number 57 also matches 28 one of the raffle array last two digits selected in FIG. 4 on the keno game board 24. Further, the last four raffle array 38 numbers 0657 match 28 one of the twelve event codes 46 selected, see FIG. 5 Ten Pin Championship.

Shown in FIG. 6A, is one of the tournament events 40 arranged for the event code 46 number 0657. The operator 16 uses the computer system 80 to arrange the tournament events 40 on a tournament board 42. The copy of each ticket 30 having a raffle array 38 matching 28 the event code 46 numbered 0657 is placed in sequential order on the tournament board 42. The copy of ticket 30 with the raffle array 38 numbered 000320657 found on FIG. 6 is placed into an event slot 54 lettered and numbered RA. 3 for the event code 46 numbered 0657. The tournament event identifier 44 numbered and lettered EC 0657 TE 4 identifies the specific tournament event 40. The operator 16 randomly selects a tournament value 50 from the set of tournament values 140 to 300 for each ticket array 38 in the tournament event 40. The tournament values 50 are determined by the tournament value parameters 52; type of values, range of values, and how to rank values. The ticket 30 with the raffle array 38 numbered 000320657 receives a bowling score of 226. The bowling scores are ranked from highest to lowest, which makes 226 the seventh best score. The raffle array 38 numbered 000310657 wins the tournament event 40 and advances to the next tournament event 40.

Shown in FIG. 7 is the ticket 30 of one embodiment used for the RTG 20. The ticket 30 shows the rules 31, the title 32, Tour Pro Open, the game data, game number, date, time, and price, the picks to win 36 the lotto, lottery game, the raffle array 38 and finally the bar code 39. The picks to win 36 numbers arranged in columns 12 for W, 89 for 1, and 67 for N match 28 the numbers selected in FIG. 4 on the lotto, lottery game board 25 for an Any Win. Further, the last five raffle array 38 numbers 76282 also match 28 one of the twelve event codes 46 selected, see FIG. 5 Tour Pro Open.

Shown in FIG. 7A, is one of the tournament events 40 arranged for the event code 46 number 76282. The operator 16 uses the computer system 80 to arrange the tournament events 40 on a tournament board 42. The copy of each ticket 30 having a raffle array 38 matching 28 the event code 46 numbered 76282 is placed in sequential order on the tournament board 42. The copy of ticket 30 with the raffle array 38 numbered 001276282 found on FIG. 7 is placed into an event slot 54 lettered and numbered RA. 3 for the event code 46 numbered 76282. The tournament event identifier 44 numbered and lettered EC 76282 TE 2 identifies the specific tournament event 40. The operator 16 randomly selects a tournament value 50 from the set of tournament values −18 to +10 for each ticket array 38 in the tournament event 40. The tournament values 50 are determined by the tournament value parameters 52; type of values, range of values, and how to rank values. The ticket 30 with the raffle array 38 numbered 001276282 receives a golf score of −15 under par. The golf scores are ranked from lowest to highest, which makes −15 the best score. The raffle array 38 numbered 001276282 wins the tournament event 40 and advances to the next tournament event 40.

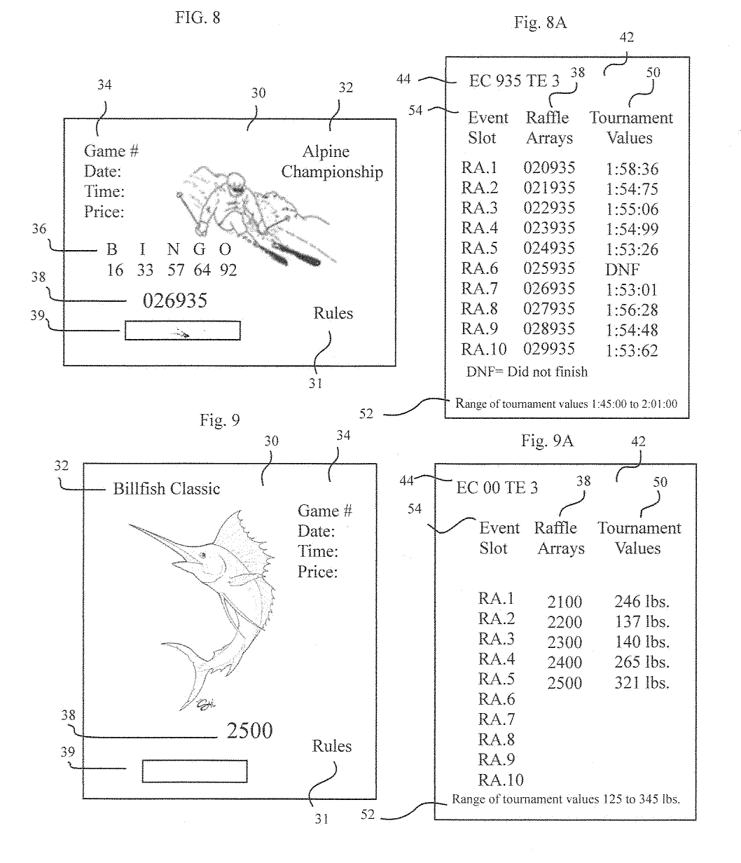

Shown in FIG. 8 is the ticket 30 of one embodiment used for the RTG 20. The ticket 30 shows the rules 31, the title 32, Alpine Championship, the game data, game number, date, time, and price, the picks to win 36 the bingo game, the raffle array 38 and finally the bar code 39. The picks to win 36 numbered letters, B16, 1 33, N 57 G 64 and 0 92 do not match 28 the numbers selected in FIG. 4 on the bingo game board 23. The last two digits of the raffle array 38 number 35 matches 28 the special raffle array last two digits selected in FIG. 4 on the bingo game board 23. Further, the last three raffle array 38 numbers 935 match 28 one of the twelve event codes 46 selected, see FIG. 5 Alpine Championship.

Shown in FIG. 8A, is one of the tournament events 40 arranged for the event code 46 number 935. The operator 16 uses the computer system 80 to arrange the tournament events 40 on a tournament board 42. The copy of each ticket 30 having a raffle array 38 matching 28 the event code 46 numbered 935 is placed in sequential order on the tournament board 42. The copy of ticket 30 with the raffle array 38 numbered 026935 found on FIG. 8 is placed into an event slot 54 lettered and numbered RA. 7 for the event code 46 numbered 935. The tournament event identifier 44 numbered and lettered EC 935 TE 3 identifies the specific tournament event 40. The operator 16 randomly selects a tournament value 50 from the set of tournament values 1:45:00 to 2:01:00 for each ticket array 38 in the tournament event 40. The tournament values 50 are determined by the tournament value parameters 52; type of values, range of values, and how to rank values. The ticket 30 with the raffle array 38 numbered 026935 receives a time of 1:53:01 for the downhill. The downhill times are ranked from lowest to highest, which makes 1:53:01 the best time in the downhill. The raffle array 38 numbered 026935 wins the tournament event 40 and advances to the next tournament event 40.

Shown in FIG. 9 is the ticket 30 of one embodiment used for the RTG 20. The ticket 30 shows the rules 31, the title 32, Billfish Classic, the game data, game number, date, time, and price, the raffle array 38 and finally the bar code 39. The last two digits of the raffle array 38 number 00 does not match 28 any of the raffle drawings 27 selected in FIG. 4 on the raffle game board 22. However, the last two digits of raffle array 38 numbers 00 match 28 one of the twelve event codes 46 selected, see FIG. 5 Billfish Classic.

Shown in FIG. 9A, is one of the tournament events 40 arranged for the event code 46 number 00. The operator 16 uses the computer system 80 to arrange the tournament events 40 on a tournament board 42 for the RTG 20 titled the Billfish Classic. The copy of each ticket 30 having a raffle array 38 matching 28 the event code 46 numbered 00 is placed in sequential order on the tournament board 42. The copy of ticket 30 with the raffle array 38 numbered 2500 found on FIG. 9 is placed into an event slot 54 lettered and numbered RA. 5 for the event code 46 numbered 00. The tournament event identifier 44 numbered and lettered EC 00 TE 3 identifies the specific tournament event 40. The operator 16 randomly selects a tournament value 50 from the set of tournament values 125 lbs. To 345 lbs. for each ticket array 38 in the tournament event 40. The tournament values 50 are determined by the tournament value parameters 52; type of values, range of values, and how to rank values. The ticket 30 with the raffle array 38 numbered 2500 catches a blue marlin with a weight of 321 lbs. The weights of the blue marlins are ranked from heaviest to lightest which makes 321 lbs. the heaviest blue marlin. The raffle array 38 numbered 2500 wins the tournament event 40 and advances to the next tournament event 40.

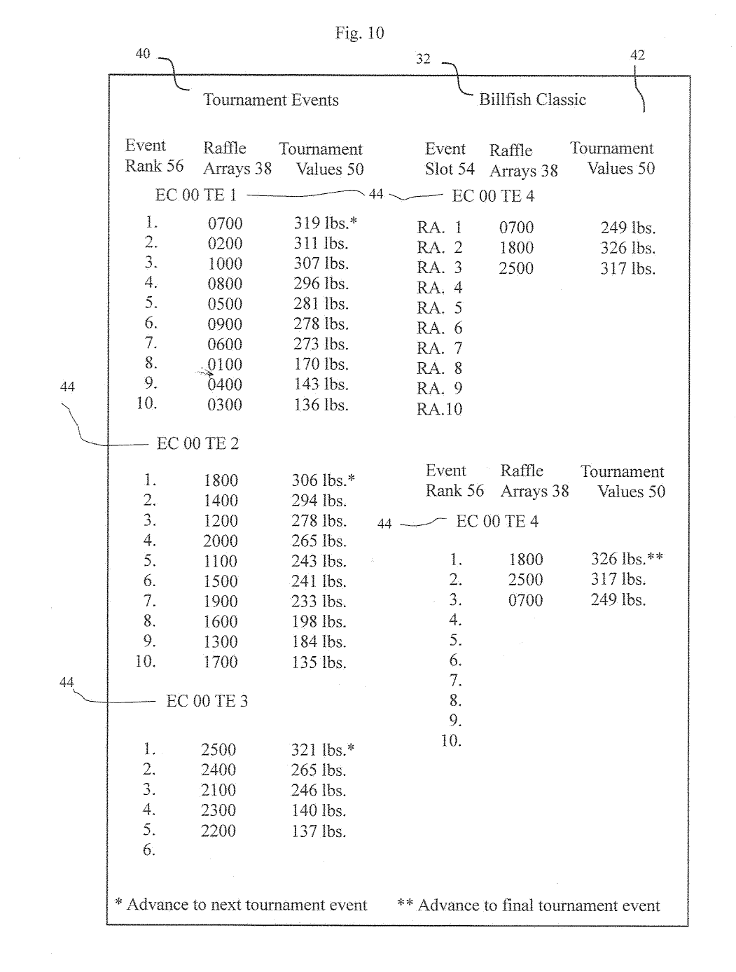

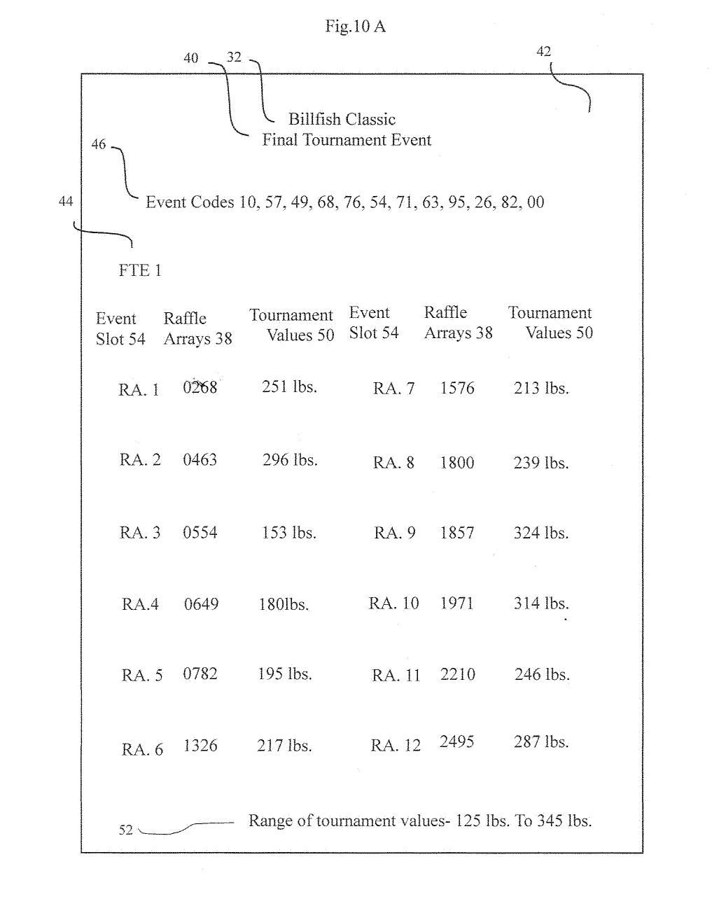

Shown in FIG. 10 is the RTG 20 titled the Billfish Classic. The operator 16 uses tournament boards 42 to display the tournament events 40 for event code 46 numbered 00. After the random selection of the tournament values 50 for each raffle array 38, the computer system 80 gives each raffle array 38 an event rank 56 based on the tournament value parameters 52. FIG. 10 shows the top ranked raffle arrays 38 numbered 0700,1800, and 2500 advancing to another tournament event 40 numbered and lettered EC 00 TE 4. The operator 16 randomly selects a new tournament value for each raffle array 38 for the tournament event 40 numbered and lettered EC 00 TE 4. The computer system 80 gives each raffle array 38 a new event rank 56 based on the tournament value parameters 52. The raffle array 38 numbered 1800 receives the highest event rank 56 by catching a blue marlin weighting 326 lbs. The raffle array 38 numbered 1800 wins the tournament event 40 for the event code 46 numbered 00 and advances to the final tournament event 40.

Shown in FIG. 10 A is the final tournament event 40 identified by the tournament identifier 44 numbered and lettered FTE 1 for the RTG 20 titled Billfish Classic. The operator 16 uses tournament boards 42 to display the final tournament event 40 for the event codes 46 numbered; 10, 57, 49, 68, 76, 54, 71, 63, 95, 26, 82, and 00. The computer system 80 sequentially arranges the raffle arrays 38 onto event slots 54 located on the tournament board 42. The computer system 80 randomly selects a tournament value 50 between 125 lbs. and 345 lbs. for each raffle array 38.

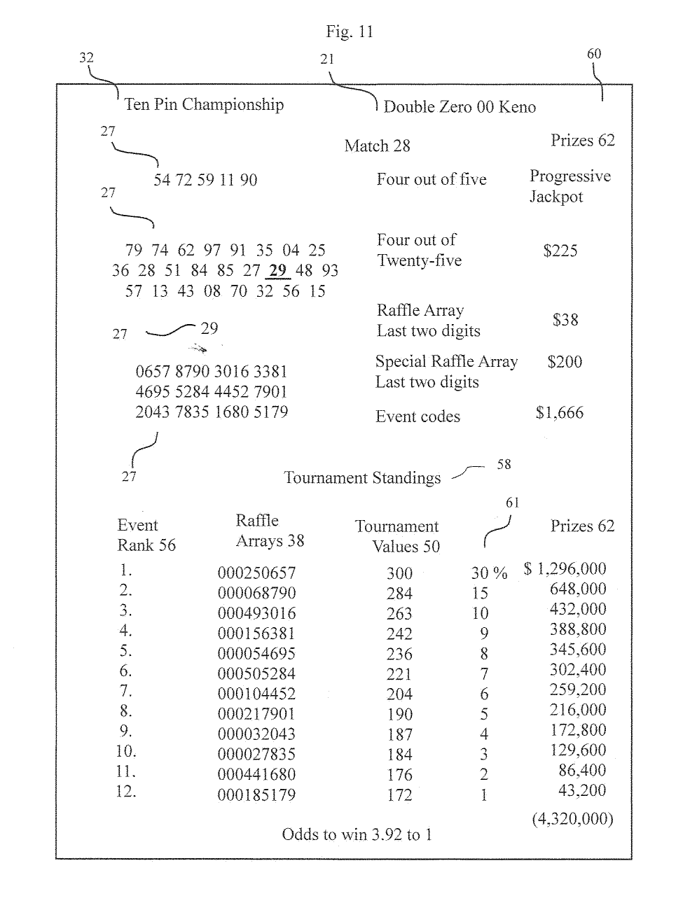

Shown in FIG. 11 is the prize board 60 for one keno embodiment of the RTG 20 titled Ten Pin Championship. The computer system 80 displays the drawings 27 for the number match game 21 and the matches 28 necessary to win the prizes 62. The tournament standings 58 reveals the tournament values 50 and the event rank 56 for each raffle array 38 in the final tournament event 40. The prizes 62 are determined by the prize percentages 61 for each event rank 56.

Preferably, the $30.00 entry fee is allocated as follows; operation costs $6.00, four out of five $1.00, four out of twenty-five $1.00, raffle arrays last two digits $10.00, special raffle arrays last two digits $2.00, event codes $2.00, and tournament standings $8.00.

For the Ten Pin championship embodiment, the RTG 20 shows that 540,000 fictitious tickets were dispensed to players. There should be a 784,245 to 1 chance to win four out of five numbers, with that player earning the progressive jackpot. There should be a 309 to 1 chance to win four out of twenty-five numbers, with 1747 potential winners earning $225.00 each. There should be 129,600 winners for the raffle arrays last two digits, with each player earning $38.00 each. There should be 5400 winners for the special raffle arrays last two digits, with each player earning $200.00 each. There should be 648 winners for the event codes, with each player earning $1,666.00 each. There should be 12 winners for the tournament standings, with each player earning a percentage of the $4,320,000. Therefore, the odds to win the Ten Pin Championship are 3779 3.92 to 1.

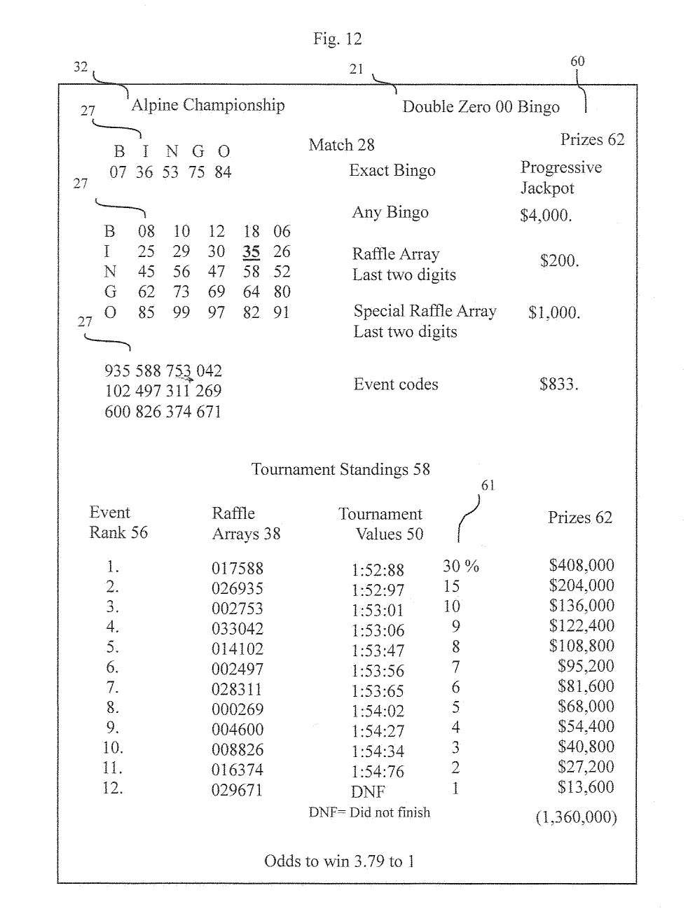

Shown in FIG. 12 is the prize board 60 for one bingo embodiment of the RTG 20 titled Alpine Championship. The computer system 80 displays the drawings 27 for the number match game 21 and the matches 28 necessary to win the prizes 62. The tournament standings 58 reveals the tournament values 50 and the event rank 56 for each raffle array 38 in the final tournament event 40. The prizes 62 are determined by the prize percentages 61 for each event rank 56.

Preferably, the $150.00 entry fee is allocated as follows; operation costs $30.00, exact bingo $5.00, any bingo $5.00, raffle arrays last two digits $50.00, special raffle arrays last two digits $10.00, event codes $10.00, and tournament standings $40.00.

For the Alpine Championship embodiment, the RTG 20 shows that 34,000 fictitious tickets were dispensed to players. There should be a 3,200,000 to 1 chance to win the exact bingo, with that player winning the progressive jackpot. There should be a 1,024 to 1 chance to win an any bingo, with 34 potential winners each earning $4,000.00 each. There should be 8500 winners for the raffle arrays last two digits, with each player earning $200.00 each. There should be 340 winners for the special raffle arrays last two digits, with each player earning $1000.00 each. There should be 408 winners for the event codes, with each player earning $833.00 each. There should be 12 winners for the tournament standings, with each player earning a percentage of the $1,360,000. Therefore, the odds to win the Alpine Championship are 3.79 3.65 to 1.

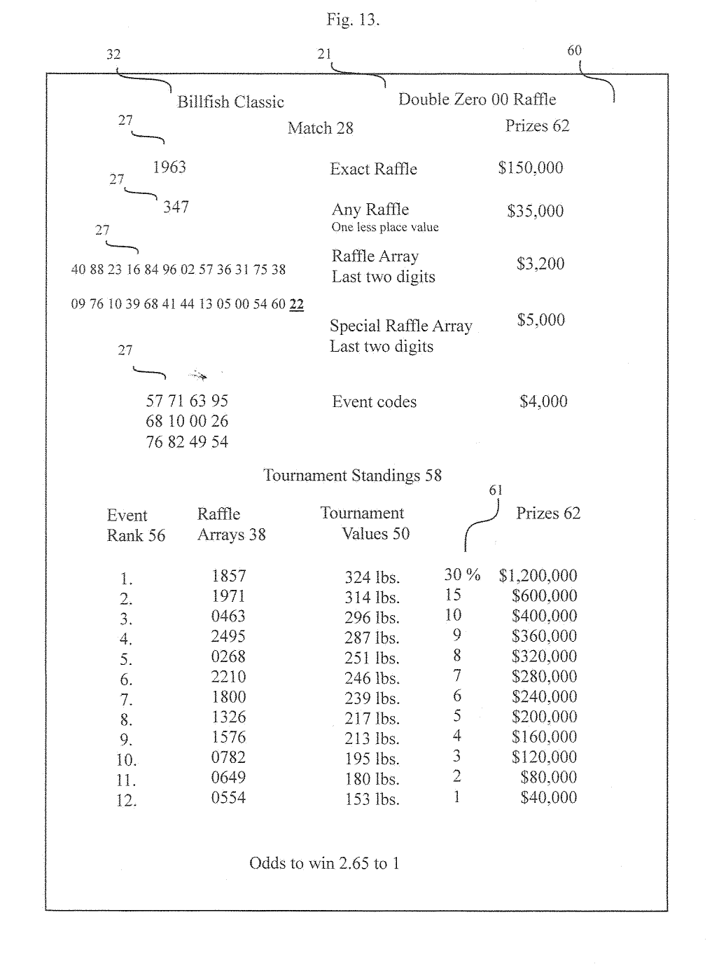

Shown in FIG. 13 is the prize board 60 for one raffle embodiment of the RTG 20 titled Billfish Classic. The computer system 80 displays the drawings 27 for the number match game 21 and the matches 28 necessary to win the prizes 62. The tournament standings 58 reveals the tournament values 50 and the event rank 56 for each raffle array 38 in the final tournament event 40. The prizes 62 are determined by the prize percentages 61 for each event rank 56.

Preferably, the $3,000.00 complimentary entry fee is allocated as follows; operation costs complimentary, exact raffle $60.00, any raffle $42.00, raffle arrays last two digits $768.00, special raffle arrays last two digits $50.00, event codes $480.00, and tournament standings $1600.00.

For the Billfish Classic embodiment, the RTG 20 shows that 2,500 fictitious complimentary tickets were dispensed to players. There should be 1 winners for the exact raffle, with the player earning $150,000. There should be 3 winners for an any raffle one less place value, with each player earning $35,000.00 each. There should be 600 winners for the raffle arrays last two digits, with each player earning $3,200.00 each. There should be 25 winners for the special raffle arrays last two digits, with each player earning $5,000.00 each. There should be 300 winners for the event codes, with each player earning $4,000.00 each. There should be 12 winners for the tournament standings, with each player earning a percentage of the $4,000,000. Therefore, the odds to win the Billfish Classic are 2.65 to 1.

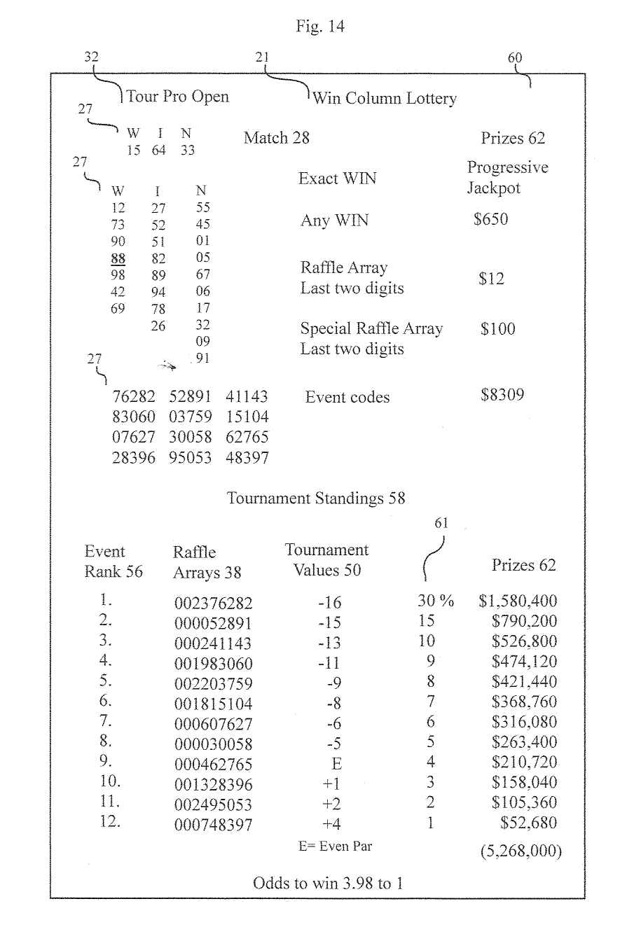

Shown in FIG. 14 is the prize board 60 for one lotto, lottery embodiment of the RTG 20 titled Tour Pro Open. The computer system 80 displays the drawings 27 for the number match game 21 and the matches 28 necessary to win the prizes 62. The tournament standings 58 reveals the tournament values 50 and the event rank 56 for each raffle array 38 in the final tournament event 40. The prizes 62 are determined by the prize percentages 61 for each event rank 56.

Preferably, the $10.00 entry fee is allocated as follows; operation costs $2.00, exact win 0.50 cents, any win 0.50 cents, raffle arrays last two digits $3.00, special raffle arrays last two digits $1.00, event codes $1.00, and tournament standings $2.00.

For the Tour Pro Open embodiment, the RTG 20 shows that 2,634,000 fictitious tickets were dispensed to players. There should be 3 potential winners for the exact win, with each player earning $439,000 each. There should be 1520 potential winners for an any win, with each player earning $650.00 each. There should be 632,160 winners for the raffle arrays last two digits, with each player earning $12.00 each. There should be 26,340 winners for the special raffle arrays last two digits, with each player earning $100.00 each. There should be 317 winners for the event codes, with each player earning $8,309.00 each. There should be 12 winners for the tournament standings, with each player earning a percentage of the $5,268,000. Therefore, the odds to win the Tour Pro Open are 3.98 to 1.

### Operation

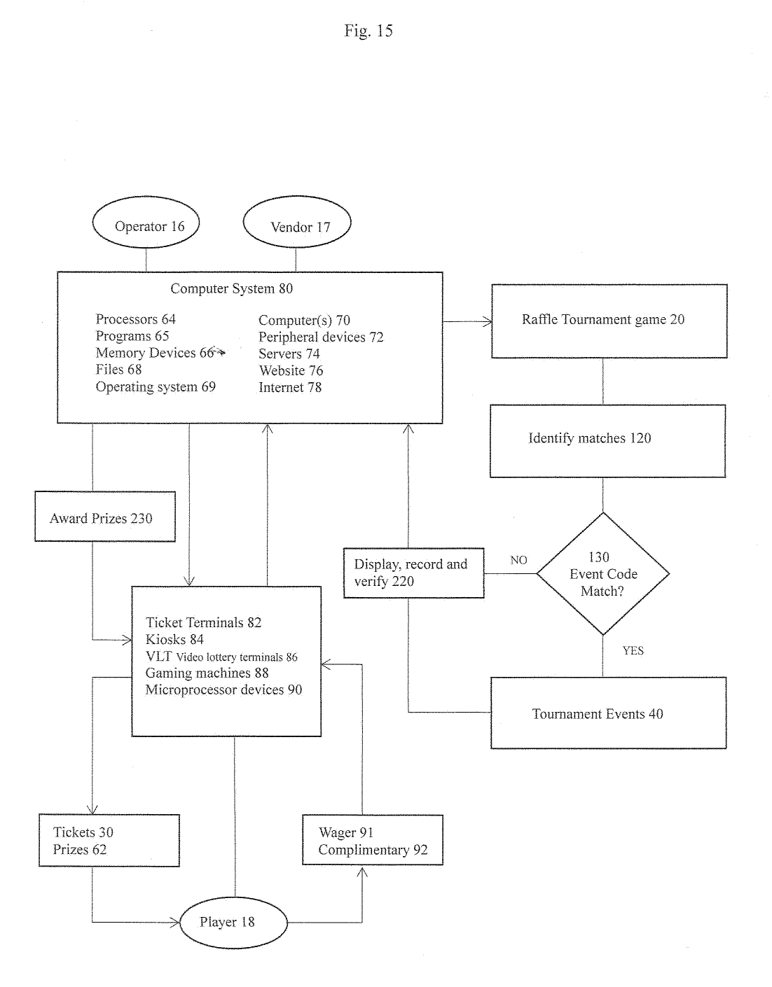

Shown in FIG. 15 is the flowchart for one possible computer system 80 to operate the RTG 20. The operator 16 in collaboration with vendor(s) 17 uses peripheral devices 72 to input and output data necessary to design and conduct the RTG 20. The computer(s) 70 uses processor(s) 64, programs 65, memory devices 66, files 68, operating systems 69, servers 74, websites 76, and the internet 78 to schedule tasks, execute applications, carry out an arbitrary set of arithmetic or logical operations and control peripheral devices 72 necessary to operate the RTG 20.

Preferably, to expedite the RTG 20, the operator 16 conducts the RTG 20 on secure servers 74 in the computer system 80 with no access from players 18. The results of the RTG 20 are announced using peripheral devices 72 and web sites 76 through the internet 78.

Preferably, the players 18 can access the RTG 20 using a variety of devices comprising; ticket terminals 82, kiosks 84, VLT's video lottery terminals 86, gaming machines 88, and microprocessor devices 90, which comprise; smartphones, desktops, laptops, tablets, and similar devices.

Preferably, the player 18 places a wager 91 or a complimentary wager 92 with the vendor 17 to receive a printed or an electronic ticket 30 for the RTG 20. The player 18, when redeeming winning tickets 30, receives prizes from the vendor 17 for a specific match and/or a specific ranking.

### CONCLUSION, RAMIFICATIONS, AND SCOPE

Accordingly, the reader will see that the raffle tournament game design provides a novel method to play themed raffle tournament games using a variety of number match game types. The novel method uses multiple drawings with at least one set of tournament events for a predetermined number of event codes with each event code having a predetermined number of randomly drawn playing symbols for a predetermined number of place values based on the total number of tickets dispensed to players, each said tournament event having a predetermined number of event slots, assigning in sequential order said tickets with said raffle arrays matching said event codes into said event slots, randomly selecting at least one tournament value from the at least one set of tournament values for each said ticket in each said tournament event, ranking said tickets according to said rules, advancing winners to another said tournament event until there is only one winner for each said event code, when there is one winner for each said event code, advancing winners to a final said tournament event, randomly selecting at least one tournament value for each said ticket and ranking said tickets on a tournament standings according to said rules. The advantages of the raffle tournament game design permit the operator to;
Provide a computer system programmed with a novel method to conduct a variety of themed tournament games to make the games quick, easy, and fun to play.
Provide tournament games with odds to win comparable to instant win lottery scratchers
Provide alternative to instant win games, which are costly to develop and difficult to shut down.
Provide a variety of number match game types to attract players from different target markets.
Provide tournament games with competitive prizes and multiple ways to win.

Therefore, the foregoing is considered as illustrative only of the principles of the invention. Further, since numerous modifications and changes will readily occur to those skilled in the art, it is not desired to limit the invention to the exact steps shown and described, and accordingly, all suitable modifications, steps, combinations of steps, features and equivalents that may be resorted to, to provide a raffle tournament game fall within the scope of the invention. Thus, the scope of the embodiments should be determined by the appended claims and their legal equivalents, rather than by the examples given.

What is claimed:

1. A raffle tournament game, comprising;
(a) at least one number match game, said number match game being at least one variation from a group of bingo, keno, lotto, and lottery, said number match game having at least one set of playing symbols, said playing symbols being at least one from a group of numbers, numerals, letters, symbols, and colors and at least one drawing, said drawing having a randomly selected subset of said playing symbols from the set of said playing symbols,
(b) at least one set of tickets, said tickets having at least one set of picks to win, a tournament entry code, and a match code, dispensing said tickets to players who make one of the following; a wager, a complementary wager, stopping disbursement of said tickets at a predetermined time, confirming the total number of said tickets dispensed to said players,
(c) at least one tournament game, drawing a predetermined number of event codes for each said tournament game, said tournament game having at least one set of tournament events for each said event code, each said tournament event having a predetermined number of event slots, assigning match codes matching said event codes in sequential order onto said event slots, randomly selecting at least one tournament value from the at least one set of tournament values for each match code in each tournament event, ranking said match codes according to a set of rules, advancing winners to another said tournament event until there is only one winner for each said event code, when there is one winner for each said event code, advancing winners to a final said tournament event, randomly selecting at least one tournament value for each match code and ranking said match codes onto a tournament standings according to said rules,
(d) at least one set of prizes, assigning a prize percentage for each event rank on the tournament standings, displaying, recording, verifying, allocating and awarding said prizes to players with said tickets having at least one of the following; specific match, specific ranking,

2. The raffle tournament game of claim 1 wherein said tickets being at least one of the following; physical ticket, electronic ticket, further said tickets having rules, game data, and a bar code, using a computer system over a secure network for dispensing said tickets with raffle arrays in sequential order to said players, said raffle arrays being at least one of the following; numbers, numerals, letters, symbols, and colors, using the last two digits of said raffle arrays to compare with the selected subset of said playing symbols from said number match game type, whereby said tickets having a match are awarded a prize based on the specific match type,

3. The raffle tournament game of claim 1 wherein selecting at least one number match game variation from a group of number match game types comprising; bingo, keno, lotto, and lottery, for one type of keno game variation, randomly selecting a predetermined number playing symbols with two digit numbers numbered 01 to 00, with 00 being 100, for one type of bingo game variation, randomly selecting a predetermined number playing symbols with two digit numbers numbered and lettered B 01 to 20, 1 21 to 40, N 41 to 60, G 61 to 80, and 0 81 to 00, with 00 being 100, with a predetermined number of letters used to identify specific rows and columns in which said playing symbols are selected, for one type of lotto, lottery game variation, randomly selecting a predetermined number playing symbols with two digit numbers numbered 01 to 00, with 00 being 100, with a predetermined number of letters used to identify specific rows and columns in which said playing symbols are selected, for one type of raffle game, randomly selecting a predetermined number playing symbols with two digit numbers numbered 01 to 00, with 00 being 100, where the last two digits of the raffle array must match said playing symbols selected, for one type of raffle game, randomly selecting a playing symbol from a predetermined number of playing symbols from O to 9 for a predetermined number of place values, where the raffle array must match the playing symbols selected, whereby said tickets having plying symbols matching the selected playing symbols from the number match game type are awarded a prize based on the specific match type,

4. The tournament game of claim 1 wherein randomly selecting a predetermined number of event codes, said event codes being at least one from a group of numbers, numerals, letters, symbols, for each said event code, randomly selecting a playing symbol from 0 to 9 for each place value of the total number of tickets dispensed to players up to one of the following; zero place values away from the total, one place value away from the total, two place values away from the total, three place values away from the total, four place values away from the total, five place values away from the total, six place values away from the total, seven place values away from the total, eight place values away from the total, nine place values away from the total, said event code identifies said playing symbols which need to match the specific subset of said playing symbols on said raffle array, whereby matching said raffle array to said event code achieves an entry into said tournament event,

5. The raffle tournament game of claim 1 wherein said tournament values being at least one from a group of weights and measurement, numbers, numerals, letters, symbols, and colors, further said tournament values being determined by the tournament value parameters, said tournament value parameters determining the type of said tournament values, the range of said tournament values and how to rank said tournament values,

6. The raffle tournament game of claim 1 wherein using said computer system for identifying tickets with matching playing symbols, further identifying tickets with raffle arrays matching said event codes, arranging electronic copies of said tickets matching said event codes into tournament events, conducting said tournament events, displaying results of said number match game and said tournament events on a prize board, recording, verifying, allocating and awarding said prizes to players with said tickets having a specific match and a specific ranking, whereby saving the operator time, money, and labor to conduct said raffle tournament game,

7. A method for conducting a tournament game comprising the steps of;
a). dispensing tickets from at least one set of tickets with raffle arrays in sequential order to players who make one of the following; a wager, a complimentary wager, stopping disbursement of said tickets at a predetermined time, confirming the total number of said tickets dispensed to said players,
b). drawing a predetermined number of playing symbols from the set of said playing symbols for at least one number match game variation, said number match game being at least one variation from a group of bingo, keno, lotto, and lottery, further drawing a predetermined number of event codes based on the total number of tickets dispensed to players,
(c). identifying tickets with matching playing symbols, further identifying tickets with raffle arrays matching said event codes, whereby matching said event code wins a player a spot in the tournament event for said event code,
d). conducting said tournament events, arranging a predetermined number of tournament events for each said event code, assigning sequentially tickets with said raffle arrays matching said event codes into a predetermined number of event slots, randomly selecting at least one tournament value for each raffle array in each tournament event, ranking said tournament values per a set of rules, advancing winners to another tournament event until there is only one winner for each event code, advancing said winners of each said event code to a final tournament event, randomly selecting at least one tournament value for each said raffle array and ranking said tournament values of each said raffle array on the tournament standings
e). assigning a prize percentage to each event rank on the tournament standings, displaying, recording, verifying, and awarding the at least one set of prizes to players having tickets with at least one of the following; a specific match, specific ranking,

8. A method for conducting a raffle tournament game in accordance with claim 7 wherein using at least one computer system to perform operations necessary to conduct said game, said computer system comprising; at least one computer, at least one set of processors, at least one set of programs for instructing said processors, at least one memory device for storing said programs, at least one set of files, said files comprising: rules, program instructions, title, theme, game data, pay table, tickets, raffle arrays, game boards, tournament boards, tournament values, tournament value parameters, tournament standings, prize board and prizes, at least one set of peripheral devices for communicating commands and results, at least one server, said server managing the network resources and web site for said raffle tournament game, said servers linking said computers through the computer network to other computer devices, display devices, ticket terminals, kiosks, VLT's and gaming machines,

9. A method for conducting a raffle tournament game in accordance with claim 7 wherein using said computer system over a secure network for dispensing said tickets to said players, said tickets being at least one of the following; physical ticket, electronic ticket, further using said computer system for confirming the total number of tickets dispensed, whereby using the information to calculate the number of event codes to use and the number of place values to use for each event code,

10. A method for conducting said raffle tournament game in accordance with claim 7 wherein selecting at least one number match game variation from a group of number match game types comprising; raffle, bingo, keno, lotto, and lottery, for one type of keno game, randomly selecting a predetermined number playing symbols with two digit numbers numbered 01 to 00, with 00 being 100, for one type of bingo game, randomly selecting a predetermined number playing symbols with two digit numbers numbered and lettered B 01 to 20, 1 21 to 40, N 41 to 60, G 61 to 80, and 0 81 to 00, with 00 being 100, with a predetermined number of letters used to identify specific rows and columns in which said playing symbols are selected, for one type of lotto, lottery game, randomly selecting a predetermined number playing symbols with two digit numbers numbered 01 to 00, with 00 being 100, with a predetermined number of letters used to identify specific rows and columns in which said playing symbols are selected, for one type of raffle game, randomly selecting a predetermined number playing symbols with two digit numbers numbered 01 to 00, with 00 being 100, where the last two digits of the raffle array must match said playing symbols selected, for one type of raffle game, randomly selecting a playing symbol from a predetermined number of playing symbols from O to 9 for a predetermined number of place values, where the raffle array must match the playing symbols selected, whereby matching the selected playing symbols from the number match game type achieves a winning ticket for said player,

11. A method for conducting said raffle tournament game in accordance with claim 7 wherein randomly selecting a predetermined number of event codes, said event codes being at least one from a group of numbers, numerals, letters, symbols, for each said event code, randomly selecting a playing symbol from O to 9 for each place value of the total number of tickets dispensed to players up to one of the following; zero place values away from the total, one place value away from the total, two place values away from the total, three place values away from the total, four place values away from the total, five place values away from the total, six place values away from the total, seven place values away from the total, eight place values away from the total, nine place values away from the total, said event code identifies said playing symbols which need to match the specific subset of said playing symbols on said raffle array, whereby matching said raffle array to said event code achieves an entry into said tournament event,

12. A method for conducting said tournament game in accordance with claim 7 wherein said tournament values being at least one from a group of weights and measurement, numbers, numerals, letters, symbols, and colors, further said tournament values being determined by the tournament value parameters, said tournament value parameters determining the type of said tournament values, the range of said tournament values and how to rank said tournament values,

13. A method for conducting said raffle tournament game in accordance with claim 7 wherein using said computer system for identifying tickets with matching playing symbols, further identifying tickets with raffle arrays matching said event codes, arranging electronic copies of said tickets matching said event codes into tournament events, conducting said tournament events, displaying results of said number match game and said tournament events on a prize board, recording, verifying, allocating and awarding said prizes to players with said tickets having a specific match and a specific ranking, whereby saving the operator time, money, and labor to conduct said raffle tournament game,

14. A method for designing and playing a tournament game comprising;
(a) selecting at least one number match game variation, said number match game being one from a group of raffle, bingo, keno, lotto, and lottery, said number match game having at least one set of playing symbols, said playing symbols being at least one from a group of numbers, numerals, letters, symbols, and colors and at least one drawing, said drawing having a randomly selected subset of said playing symbols from the set of said playing symbols, further drawing a predetermined number of event codes, for each said event code, randomly drawing a predetermined number of playing symbols for a predetermined number of place values based on the total number of tickets dispensed to players,
(b) selecting at least one set of tickets, said tickets having a bar code, rules, game data, a raffle array, and at least one set of picks to win when playing bingo, keno, lotto, and lottery, dispensing said tickets with raffle arrays in sequential order to players who make one of the following; a wager, a complementary wager, stopping disbursement of said tickets at a predetermined time, confirming the total number of said tickets dispensed to said players, identifying said tickets with matching playing symbols, further identifying tickets with raffle arrays matching said event codes, whereby matching said event code entitles said player to enter a tournament event for said event code,
(c) selecting at least one tournament, said tournament having at least one set of tournament events for a predetermined number of event codes, each said tournament event having a predetermined number of event slots, assigning in sequential order said tickets with said raffle arrays matching said event codes into said event slots, randomly selecting at least one tournament value from the at least one set of tournament values for each said ticket in each said tournament event, ranking said tickets according to said rules, advancing winners to another said tournament event until there is only one winner for each said event code, when there is one winner for each said event code, advancing winners to a final said tournament event, randomly selecting at least one tournament value for each said ticket and ranking said tickets on a tournament standings according to said rules,
(d) selecting at least one set of prizes, assigning a prize percentage to each event rank on the tournament standings, displaying, recording, verifying, and awarding the at least one set of prizes to players having tickets with at least one of the following; a specific match, specific ranking,

15. A method for designing and playing a raffle tournament game in accordance with claim 14, wherein using a theme to create said raffle tournament game, devising a set of rules, a set of program instructions, a pay table, selecting a title, the price of a ticket, the length of said game, the game number, and the tournament value parameters, further using at least one computer system to perform operations necessary to conduct the raffle tournament game,

16. A method for designing and playing a raffle tournament game in accordance with claim 14, wherein using a computer system over a secure network for dispensing said tickets to said players, said tickets being at least one of the following; physical ticket, electronic ticket, further using said computer system for confirming the total number of tickets dispensed, whereby using the information to calculate the number of event codes to use and the number of place values to use for each event code,

17. A method for designing and playing a raffle tournament game in accordance with claim 14 wherein selecting at least one number match game variation from a group of number match game types comprising; raffle, bingo, keno, lotto, and lottery, for one type of keno game, randomly selecting a predetermined number playing symbols with two digit numbers numbered 01 to 00, with 00 being 100, for one type of bingo game, randomly selecting a predetermined number of playing symbols with two digit numbers numbered and lettered B 01 to 20, 1 21 to 40, N 41 to 60, G 61 to 80, and 0 81 to 00, with 00 being 100, with a predetermined number of letters used to identify specific rows and columns in which said playing symbols are selected, for one type of lotto, lottery game, randomly selecting a predetermined number playing symbols with two digit numbers numbered 01 to 00, with 00 being 100, with a predetermined number of letters used to identify specific rows and columns in which said playing symbols are selected, for one type of raffle game, randomly selecting a predetermined number playing symbols with two digit numbers numbered 01 to 00, with 00 being 100, where the last two digits of the raffle array must match said playing symbols selected, for one type of raffle game, randomly selecting a playing symbol from a predetermined number of playing symbols from O to 9 for a predetermined number of place values, where the raffle array must match the playing symbols selected, whereby matching the selected playing symbols from the number match game type achieves a winning ticket for said player,

18. A method for designing and playing a raffle tournament game in accordance with claim 14, wherein randomly selecting a predetermined number of event codes, said event codes being at least one from a group of numbers, numerals, letters, symbols, for each said event code, randomly selecting a playing symbol from O to 9 for each place value of the total number of tickets dispensed to players up to one of the following; zero place values away from the total, one place value away from the total, two place values away from the total, three place values away from the total, four place values away from the total, five place values away from the total, six place values away from the total, seven place values away from the total, eight place values away from the total, nine place values away from the total, said event code identifies said playing symbols which need to match the specific subset of said playing symbols on said raffle array, whereby matching said raffle array to said event code achieves an entry into said tournament event,

19. A method for designing and playing a raffle tournament game in accordance with claim 14, wherein said tournament values being at least one from a group of weights and measurement, numbers, numerals, letters, symbols, and colors, further said tournament values being determined by the tournament value parameters, said tournament value parameters determining the type of said tournament values, the range of said tournament values and how to rank said tournament values,

20. A method for designing and playing a raffle tournament game in accordance with claim 14, wherein using said computer system for identifying tickets with matching playing symbols, further identifying tickets with raffle arrays matching said event codes, arranging electronic copies of said tickets matching said event codes into tournament events, conducting said tournament events, displaying results of said number match game and said tournament events on a prize board, recording, verifying, allocating and awarding said prizes to players with said tickets having a specific match and a specific ranking, whereby saving the operator time, money, and labor to conduct said raffle tournament game,
